(19) United States
(12) Patent Application Publication
(10) Pub. No.: US 2012/0250463 A1
(43) Pub. Date: Oct. 4, 2012

(54) GUIDING SOUND GENERATING APPARATUS AND NON-TRANSITORY COMPUTER READABLE MEDIUM

(75) Inventors: Kaori ENDO, Kawasaki (JP); Yoshiteru TSUCHINAGA, Fukuoka (JP)

(73) Assignee: FUJITSU LIMITED, Kawasaki-shi (JP)

(21) Appl. No.: 13/274,215

(22) Filed: Oct. 14, 2011

(30) Foreign Application Priority Data
Mar. 31, 2011 (JP) 2011-081281

(51) Int. Cl. G01S 3/80; H04B 1/02

(52) U.S. Cl. 367/119; 367/138

(57) ABSTRACT

A guiding sound generating apparatus which generates a guiding sound for guidance from a present location to a destination, the apparatus having a sound source, a variable sound-source attribute unit that changes a sound source attribute depending on a position or a positional change of a present location with respect to a destination, and an attribute-application unit that applies the sound-source attribute generated from the variable sound-source attribute unit to the sound source and generates a guiding sound where a sound-source attribute is changed by the position or positional change of the present location with respect to the destination.

### CROSS-REFERENCE TO RELATED APPLICATION

This application is related to and claims priority to the previously filed Japanese Patent Application No. 2011-081281 filed on Mar. 31, 2011, the entire contents of which are herein incorporated by reference.

### BACKGROUND

1. Field

The embodiments discussed herein are related to a navigation technology for guiding a user to a destination by using a sound.

2. Background

Sound is one way to guide a person to a destination. Regarding the sound which a user hears, Japanese Laid-open Patent Publication No. 2008-209137 discloses providing a three-dimensional sound with sense of direction to a user, such that when the user hears the sound from a guiding direction, the user is led to a destination.

Regarding an amplitude difference or an phase difference between sounds, Japanese Laid-open Patent Publication No. 6-261399 describes that stereo sounds (i.e., sounds emitted from two or more sound sources) cause a sound pressure difference or transmission time difference (phase difference) between the right and left ears of a listener. This difference between the sounds transmitted to the right and left ears of the listener provide the sound with localization.

Regarding a sound image and a frequency, Japanese Laid-open Patent Publication No. 6-269097 describes that a frequency bandwidth with forward localization is emphasized to localize the sound image of an audio signal in a forward direction.

Regarding guidance with a sound effect, Japanese Laid-open Patent Publication No. 2008-286749 describes sound effects which are reproduced depending on distances from a proximate guiding position.

### SUMMARY

According to an aspect of the embodiments discussed herein, there is provided a guiding sound generating apparatus which generates a guiding sound for guidance from a present location to a destination, the guiding sound generating apparatus having a sound source, a variable sound-source attribute unit that changes a sound source attribute depending on a position or a positional change of a present location with respect to the destination, and an attribute-application unit that applies the sound-source attribute generated from the variable sound-source attribute unit to the sound source and generates a guiding sound where a sound-source attribute is changed by the position or the positional change of the present location with respect to the destination.

The object and advantages of the invention will be realized and attained by means of the elements, features, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary guiding sound generating apparatus according to a first embodiment;

FIG. 2 illustrates an exemplary positional relationship between a user and a destination;

FIG. 3 illustrates an exemplary process for generating a guiding sound;

FIG. 4 illustrates an exemplary guiding sound generating apparatus;

FIG. 5 illustrates an exemplary guiding sound generating apparatus according to a second embodiment;

FIG. 6 illustrates an exemplary distance and an exemplary direction of a stereophonic sound source;

FIG. 7 illustrates an exemplary positional relationship among a user, a destination, and a sound source;

FIG. 8 illustrates an exemplary saw-tooth waveform as an exemplary function f1 (t);

FIG. 9 illustrates an exemplary saw-tooth waveform as an exemplary function f2 (t);

FIG. 10 illustrates an exemplary function R;

FIG. 11 illustrates an exemplary guiding sound generating apparatus according to a third embodiment;

FIG. 12 illustrates an exemplary guiding sound generating apparatus according to a fourth embodiment;

FIG. 13 illustrates an exemplary guiding sound generating apparatus according to a fifth embodiment;

FIG. 14 illustrates an exemplary process for generating a guiding sound;

FIG. 15 illustrates an exemplary process for application of a sound-source attribute of a pitch;

FIG. 16 illustrates an exemplary guiding sound generating apparatus according to a sixth embodiment;

FIG. 17 illustrates an exemplary guiding sound generating apparatus according to a seventh embodiment;

FIG. 18 illustrates an exemplary inclination of a frequency characteristic;

FIG. 19 illustrates an exemplary process for application of a sound-source attribute of a frequency characteristic;

FIG. 20 illustrates exemplary regression lines and exemplary frequency characteristics before and after adjustment process;

FIG. 21 illustrates an exemplary guiding sound generating apparatus according to an eighth embodiment;

FIG. 22 illustrates an exemplary process for application of a sound-source attribute of a bandwidth;

FIG. 23 illustrates an exemplary guiding sound generating apparatus according to a ninth embodiment;

FIG. 24 illustrates an exemplary process for application of a sound-source attribute of SNR;

FIG. 25 illustrates an exemplary guiding sound generating apparatus according to a tenth embodiment;

FIG. 26 illustrates an exemplary change in position of a destination and an exemplary change in position of a sound source;

FIG. 27 illustrates an exemplary process for generating a guiding sound;

FIG. 28 illustrates an exemplary process for generating a guiding sound-source attribute;

FIG. 29 illustrates an exemplary move destination of a sound source;

FIG. 30 illustrates an exemplary process for changing a pitch of a guiding sound;

FIG. 31 illustrates an exemplary guiding sound generating apparatus according to another embodiment;

FIG. 32 illustrates an exemplary table of sound-source attributes;

FIG. 33 illustrates an exemplary table of a guiding apparatus;

FIG. 34 illustrates a modified example of function f1 (t), which is an exemplary function of a repetitive decrease;

FIG. 35 illustrates a modified example of function f2 (t), which is an exemplary function of a repetitive increase;

FIG. 36 illustrates an exemplary function θ (Φ (t)); and

FIG. 37 illustrates an exemplary change in location of a sound source.

### DESCRIPTION OF EMBODIMENTS

In order to use a sound as guiding information, a sound source installed in a mobile terminal, such as a cell phone, may be employed. In this case, the information about a direction of a destination or the like is sent to the ears of a user by means of a sound.

However, when the user is going towards the destination, it is difficult to precisely recognize the direction to the destination from the present location or changes in location of the user with respect to the destination. In other words, the sense of direction that represents the direction of a destination is hardly recognized from a sound. In addition, there is a disadvantage in that a change in location of the object is difficult to recognize when the object has moved.

According to a guiding sound generating apparatus or a guiding sound generating program disclosed in one embodiment of the following description, a positional relationship between the destination and the present location is correlated with a sound source to clearly enable a user to be guided to a destination by a sound.

The guiding sound generating apparatus or the guiding sound generating program disclosed in the following description may exert any of the following advantageous effects.

(1) A guiding sound has a sound-source attribute which depends on the current location of a user or a change in a location of the user with respect to a destination. Therefore, the sound-source attribute of a guiding sound allows the user to recognize a positional change between the destination and the current location and guides the user to the destination.

(2) The sound-source attribute of a guiding sound can be changed by the current location of a user or a change in location of the user with respect to a destination, enabling the user's auditory sensation to recognize a change in the sound-source attribute so that the user is guided to a destination.

Then, other purposes, characteristics, and advantages of the present invention will become clearer by referring to the attached drawings and each of the following embodiments.

### First Embodiment

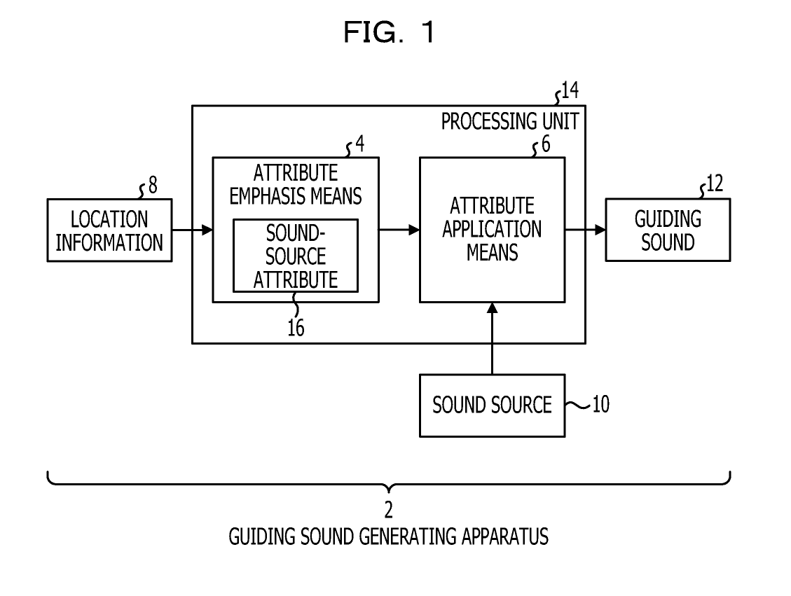

A first embodiment will be described with reference to FIG. 1. FIG. 1 is a diagram illustrating an exemplary guiding sound generating apparatus according to the first embodiment. The configuration of the guiding sound generating apparatus illustrated in FIG. 1 is for illustrative purpose only and is not intended to limit the scope of the invention.

A guiding sound generating apparatus 2 is an exemplary guiding sound generating apparatus or navigation sound generating unit. The guiding sound generating apparatus 2 generates a guiding sound for guiding a user to a destination. By execution of function of guiding a user to a destination (hereinafter, also referred to as a destination guidance function), the guiding sound generating apparatus 2 generates a guiding sound to the destination (hereinafter also referred to as a destination guidance sound). Here, the destination is a place which may be defined arbitrarily. For example, the destination may be a place where a user using the guiding sound generating apparatus 2 intends to go. This destination may be selected by the user via, for example, the guiding sound generating apparatus 2. A present location is a place where the sound generating apparatus 2 is currently located, or a place where a user using the sound generating apparatus 2 is currently located.

An attribute emphasis unit 4 may be, for example, an exemplary variable sound-source attribute unit that changes a sound-source attribute. The attribute emphasis unit 4 receives location information 8 about the destination and a location of the user and changes a sound-source attribute depending on the received location information 8. Thus, the sound-source attribute 16 is emphasized by the change and output. Examples of the sound-source attribute include: a distance between the destination and the present location; a direction or angle of the destination from the present location; a sound volume; a pitch; a sound tempo; a sound frequency characteristic; a sound frequency bandwidth; and a signal-to-noise ratio (SNR) (so-called SN ratio). These sound attributes may be used alone or may be used in combination of two or more. The emphasis of the sound-source attribute is performed by changing at least one of these sound-source attributes. When the sound-source attribute is changed, the change may significantly stimulate the user's auditory sensation compared with a chase where the sound-source attribute is not changed. Since the attribute emphasis unit 4 emphasizes the attribute of a sound source, the user of the guiding sound generating apparatus 2 is allowed to intuitively recognize the direction of the destination. Thus, the user is assisted in recognizing the destination.

The attribute application unit 6 is a unit that applies a sound-source attributes to a sound source of a guiding sound (hereinafter, also referred to as a guiding sound source). The attribute application unit 6 generates a guiding source 12 by replacing an input sound-source attribute from a sound source 10 with an emphasized sound-source attribute generated by the attribute emphasis unit 4. Since the emphasized sound-source attribute is applied to this guiding sound 12, guidance to the destination is emphasized. Thus, the destination direction may be easily recognized. The guiding sound 12 generated from the attribute application unit 6 is given to the user to be guided to the destination. When the guiding sound 12 is an air conduction sound that travels via air or the like, a guiding sound is transmitted to the user's hearing organs through the user's ears. When guiding source 12 is a bone conduction sound which is transmitted to a user via the user's bones, such as a skull, guiding source 12 is transmitted to a user's hearing via a user's skull. Here, the sound source 10 is a source of the guiding sound 12, for example, music, a voice, a melody, or a pulse or continuous sound with a specific frequency.

The attribute emphasis unit 4 and the attribute application unit 6 are installed in a processing unit 14 of the guiding sound generating apparatus 2. The processing unit 14 is a unit that performs arithmetic processing or control processing performed in the guiding sound generating apparatus 2, for example, and is able to execute a program in a central processing unit (CPU).

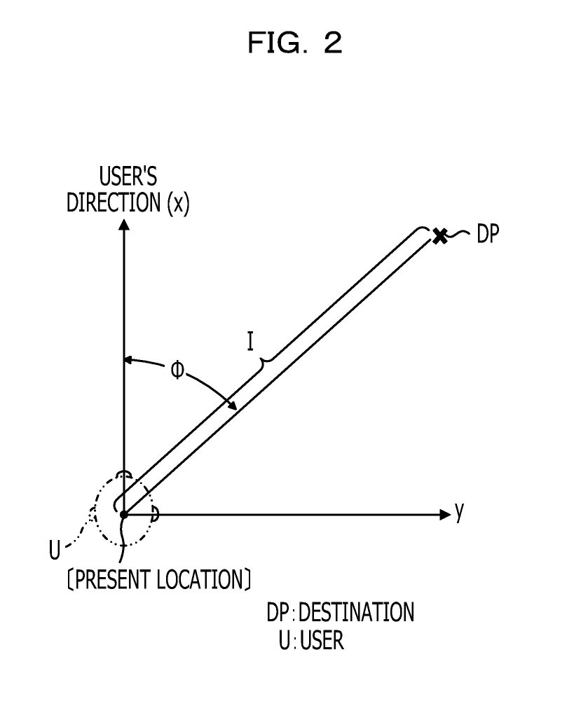

Next, FIG. 2 is referenced to describe the location information about the location of a user and the location of a destination will be described with reference to FIG. 2. FIG. 2 is a diagram illustrating an exemplary positional relationship between a user and a destination. In addition, the positional relationship illustrated in FIG. 2 is for illustrative purpose only and is not intended to limit the scope of the invention.

In FIG. 2, the position of a user U and the position of a destination DP are represented on an x-y coordinate plane. The position of the user U represents a present location of a guiding sound generating apparatus 2 and is located at the origin of the coordinate plate, or a position of x=0, y=0. The front direction of the user U is defined as an x direction of an x axis and the right-side direction of the user U is defined as a positive direction of a y axis. The destination illustrated in FIG. 2 is located on the right side in the front direction of the user U. Here, the guiding sound generating apparatus 2 is set so that the front side thereof faces toward the front side of the user U when the user U uses the guiding sound generating apparatus 2 in a general manner (hereinafter, this direction is referred to as a front direction).

A distance I between the user U and the destination DP is defined as a linear distance from the user U to the destination DP and the direction of the destination DP with respect to the user U is represented by an angle Φ. The angle Φ is defined as an angle between a front direction of the user U (front direction of the guiding sound generating apparatus 2, which is set in the apparatus 2) and the direction of the destination DP to the user U. In other words, the angle Φ is set to 0 (zero) at the front side of the user U and then measured in clockwise (right-handed) direction. Furthermore, the user U and the guiding sound generating apparatus 2 are arranged at the same position or close to each other. Thus, the distance I represents the distance of the current location from the destination and the angle Φ is the angle of the current location with respect to the destination. In other words, the distance I and the angle Φ represent the position of the current location with respect to the destination and are provided as examples of location information 8.

When the user U is moved, both the direction I and the angle Φ are changed. A position of the destination DP at time (clock time) t is represented by (distance, angle)−(l (t), Φ (t)). When the time t passes a predetermined time of Δt, the position of the destination DP at time t+Δt is represented by (distance, angle)=(l (t+Δt), Φ(t+Δt)). In this case, a variation Δl (t) of the distance at a period from time t to time t+Δt is represented by Equation (1) and a variation ΔΦ(t) of the angle is represented by Equation (2). Here, each of the variation Δl (t) of the distance and the variation ΔΦ (t) of the angle is a value that represents a variation in position of the destination DP and a variation in position of the user U. Since the user U and the guiding sound generating apparatus 2 are arranged at the same position or close to each other, each of the variation Δl (t) of the distance and the variation ΔΦ (t) of the angle is a value that represents a variation in position of the current location with respect to the destination (examples of location information 8).

Δl(t)=l(t+Δt)−l(t) (1)

ΔΦ(t)=Φ(t+Δt)−Φ(t) (2)

When the value of Δl (t) is 0 (zero), it means that distance does not change in a predetermined time period. When the value of Δl (t) is larger than 0 (zero), it means that the distance from the user to the destination increases and the destination becomes farther from the user. When the value of Δl (t) is smaller than 0 (zero), it means that the distance from the user to the destination decreases and the destination became nearer to the user. When the value of ΔΦ (t) is 0 (zero), it means that the direction of the destination does not change in a predetermined time period. When the value of ΔΦ (t) is larger than 0 (zero), it means that the angle of the destination increases and the destination became farther from the user's front direction. When the value of ΔΦ (t) is smaller than 0 (zero), it means that the angle of the destination decreases and the destination becomes closer to the user's front direction.

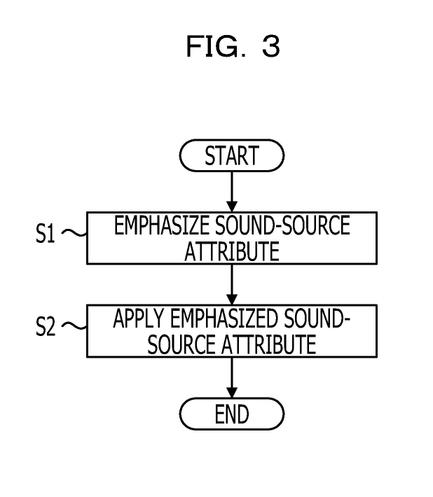

Next, FIG. 3 is referred to describe the generation of the guiding sound. FIG. 3 is a flow chart illustrating an exemplary process for generating a guiding sound. The process for generating the guiding sound is an example of the guiding sound generating program of the present disclosure is illustrative purpose only and is not intended to limit the scope of the invention.

The procedure illustrated in FIG. 3 is performed by the attribute emphasis unit 4 and the attribute application unit 6, which are installed in the processing unit 14.

When the attribute emphasis unit 4 receives information about the location of a destination and the location of a user as location information 8, the attribute emphasis unit 4 changes the sound-source attribute based on the location information about the location of the destination and the location of the user and emphasizes the sound-source attribute (Step S1). For example, the attribute emphasis unit 4 urges the user to recognize the destination. The emphasized sound-source attribute is output from attribute emphasis unit 4, and is input into the attribute application unit 6.

When the emphasized sound-source attribute and the sound source 10 are input into the attribute application unit 6, the attribute application unit 6 changes the attribute of sound source 10 into the emphasized sound-source attribute obtained in step S1, and then calculates and outputs a destination guidance sound 12 (Step S2). The emphasized sound-source attribute is applied to the sound source 10, thereby obtaining a destination guidance sound 12 which is emphasized to enable a user to easily recognize the direction of the destination. For example, the guiding sound 12 is a destination guidance sound for guiding a user to the destination.

For example, the emphasis of the destination guidance sound is performed by emphasizing a variation Δl (t) of the position or a variation ΔΦ (t) of the angle as location information 8. For example, the sound-source attribute may be varied depending on cases of a decrease, increase, and no change in the distance or angle between the user and the destination based on the variation Δl (t) of the position or the variation ΔΦ (t) of the angle.

For example, the emphasis of the destination guidance sound 12 is performed by emphasizing the position I or the angle Φ as location information 8. In this case, for example, the guiding sound 12 which is output to user's ears is controlled to make the user recognize the sound as a stereophonic sound. When the user recognizes the sound as a stereophonic sound, an audible sound spreads in three dimensions and a sense of distance and a sense of direction are established in the sound. Then, for example, the guiding sound 12 is controlled and changed so that the sound may travel from the user's position to the destination.

Thus, the sound-source attribute is emphasized and applied to the sound source, so that the guiding sound may be emphasized. The emphasized guiding sound allows the user to more easily intuitively recognize the destination. Therefore, the guidance may be easily performed.

### Second Embodiment

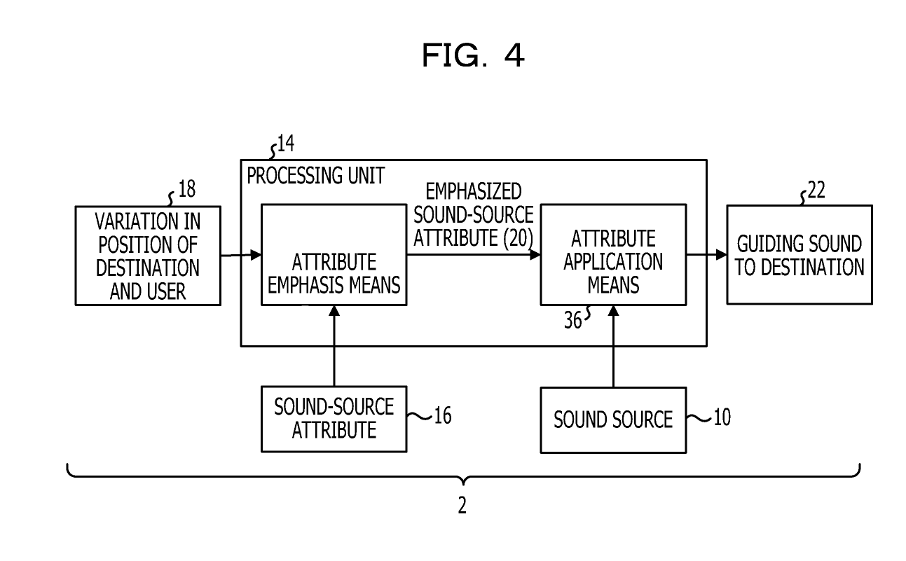

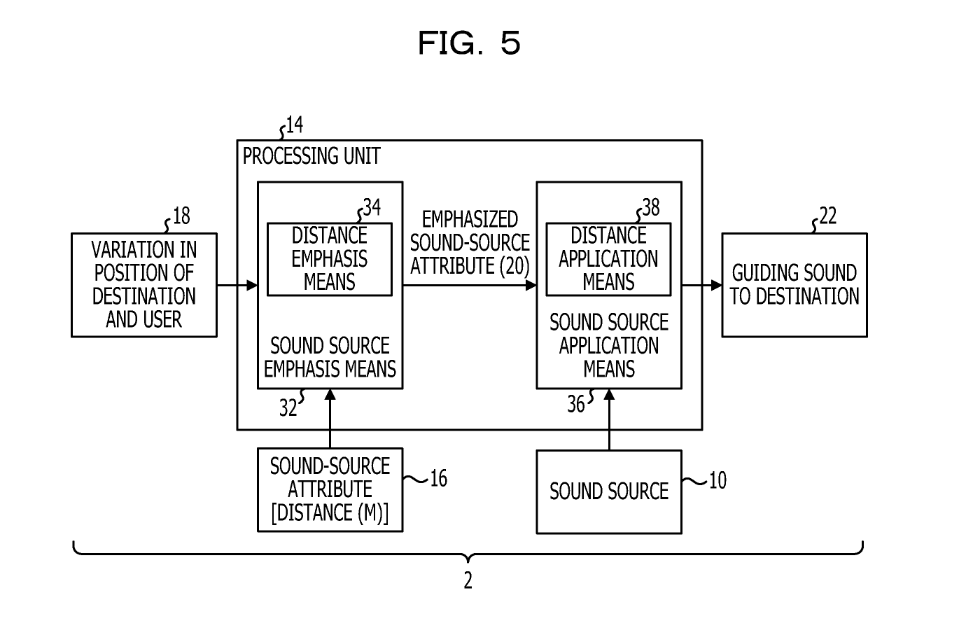

A second embodiment will be described with reference to FIG. 4 and FIG. 5. FIG. 4 is a diagram illustrating an exemplary guiding sound generating apparatus and FIG. 5 is a diagram illustrating an exemplary guiding sound generating apparatus according to the second embodiment. The configurations of the respective apparatuses illustrated in FIG. 4 and FIG. 5 are for illustrative purpose only and are not intended to limit the scope of the invention. The same reference numerals denote the same structural components as those illustrated in FIG. 1.

A sound-source attribute emphasis unit 32 illustrated in FIG. 4 is an exemplary attribute emphasis unit 4 or variable sound-source attribute unit. The sound-source attribute emphasis unit 32 accepts specification of the sound-source attribute 16, and accepts the input of a variation 18 in user's position with respect to the destination. Then, the sound-source attribute emphasis unit 32 changes the sound-source attribute 16 according to this received positional variation 18. Then, the sound-source attribute emphasis unit 32 emphasizes the sound-source attribute 16, such that the user U recognizes the direction of the destination intuitively, and outputs an emphasized sound-source attribute 20. The variation in user's position with respect to the destination is a variation in position of the current location with respect to the destination and is provided as exemplary location information 8.

The sound-source attribute application unit 36 illustrated in FIG. 4 is an exemplary attribute application unit 6. The sound-source attribute application unit 36 changes the sound-source attribute of the input sound source 10 into the emphasized sound-source attribute 20 generated by the sound-source attribute emphasis unit 32, and then generates a destination guidance sound 22. In other words, for example, the sound-source attribute application unit 36 calculates and generates the destination guidance sound 22 which is emphasized so that the direction to the destination may be easily recognized. Here, the destination guidance sound 22 is an exemplary guiding sound.

The sound-source attribute emphasis unit 32 receives inputs of a sound-source attribute 16 and a variation 18 in user's position with respect to the destination. Then, the sound-source attribute emphasis unit 32 outputs an emphasized sound-source attribute 20 according to the variation 18 in user's position with respect to the destination. Subsequently, the sound-source attribute application unit 36 emphasizes the attribute of a sound source 10. For example, when the user becomes closer to the direction of the destination, the sound-source attribute emphasis unit 32 emphasizes that sound-source attribute 16 so that the sound source 10 may be easily recognized by the user. When the user stays away from the direction of the destination, for example, the sound-source attribute emphasis unit 32 emphasizes a sound-source attribute so that the sound source 10 may be hardly recognized by the user. Since the apparatus is configured above, the sound-source attribute application unit 36 applies the emphasized sound-source attribute 20 calculated by the sound-source attribute emphasis unit 32 to the sound source 10. Thus, a sound source with an emphasized attribute is output, so that the use may be guided intelligibly.

In a case of emphasizing the sound source 10 when distance information is used as an exemplary sound-source attribute 16, the sound-source attribute emphasis unit 32 illustrated in FIG. 5 receives specification of “distance” as the sound-source attribute 16. Furthermore, the sound-source attribute emphasis unit 32 includes a distance emphasis unit 34 as a unit that emphasizes a distance between the destination and the present location to emphasize and output a distance sound-source attribute. A sound-source attribute application unit 36 illustrated in FIG. 5 includes a distance application unit 38 as a unit that applies a sound-source attribute of the distance to the sound source 10. The sound-source attribute 20 of the emphasized distance is applied to the sound source 10, thereby generating a destination guidance sound 22.

In emphasizing the distance, a stereophonic sound to be used by the user may be recognized by controlling the destination guidance sound 22 to be input into the ears of the user. Then, the user acquires a physical feeling of hearing a sound from a sound source set in a three-dimensionally extending region. Therefore, a distance and a direction may be set between the user and the sound source.

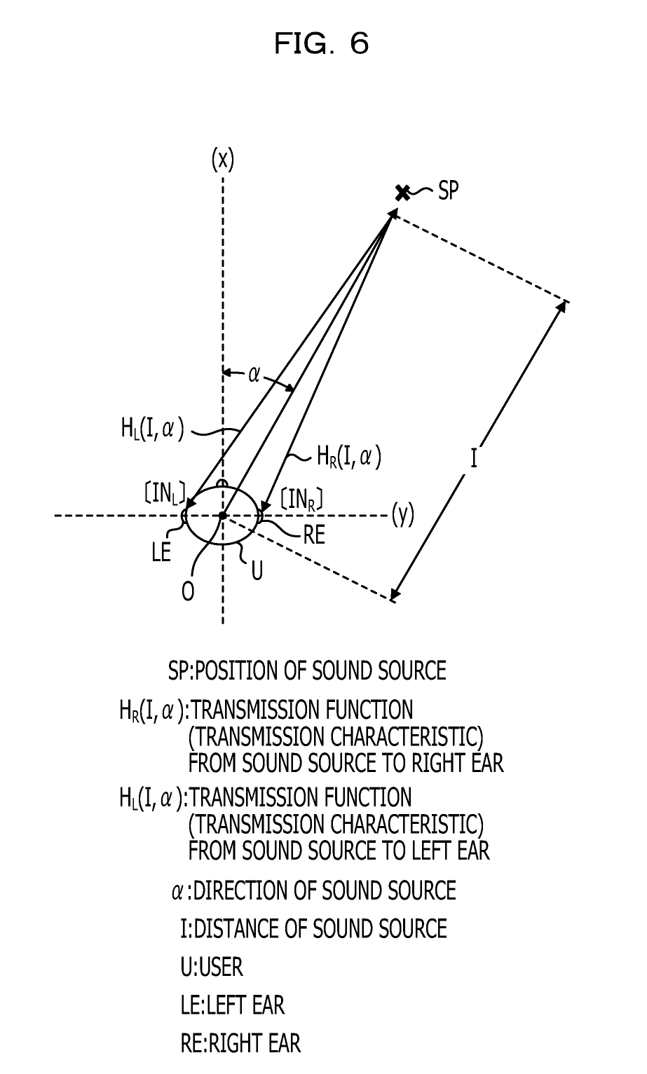

Next, with reference to FIG. 6, a direction and a distance of a stereophonic sound source will be described. FIG. 6 is a diagram illustrating an exemplary distance and an exemplary direction of a stereophonic sound source.

A user U illustrated in FIG. 6 receives a right-ear output sound, in_R (I, α, n) (=IN_{R}), in the right ear RE of the user U and a left-ear output sound, in_L (I, α, n) (=IN_{L}), in the left ear LE of the user U. In order to obtain localization of a sound source SP located in distance I and direction α, a transfer characteristic H_{R} (I, α) to the right ear RE of the user U with respect to the sound source SP at a position of distance L and direction α and a transfer characteristic H_{L} (I, α) to the left year LE of the user are measured. Then, an impulse response is obtained from the transfer characteristics.

The transfer characteristics H_{L} (I, α) and H_{R} (I, α) are complex spectra for every frequency. Impulse responses corresponding to the transfer characteristics H_{L} (I, α) and H_{R} (I, α) are represented by hrtfL (I, α, m) and hrtfR (I, α, m). Here, m is a numerical value represented by m=0, . . . , M−1. M is an impulse response length.

In order to obtain localization of a sound source SP located at a distance I in a direction α, impulse response hrtfL (I, α, m) and hrtfR (I, α, m) are superimposed on a signal sig (n) of the source to create a left-ear processing sound and a right-year processing sound. Then, the left-ear processing sound may be output to the left-ear LE of the user U and the right-ear processing sound may be output to the right-ear RE of the user U. Processing sounds to be output to the ears, or output sounds to the ear, may be represented by a function using a sound source signal and an impulse response. Generation of a left-ear processing sound and a right-ear processing sound are obtained as a right-ear output sound in_R (I, α, n) and a left-ear output sound in_L (I, α, n) and represented by Equation (3).

$$\begin{matrix}in\_L ( I , α , n ) = {\sum }_{m - 0}^{M - 1} hrtfL ( I , α , m ) \cdot sig ( n - m ) \\ in\_R ( I , α , n ) = {\sum }_{m - 0}^{M - 1} hrtfR ( I , α , m ) \cdot sig ( n - m )\end{matrix} \} \qquad ( 3 )$$

In order to change the distance of the sound source so as to be set to “r”, for example, r may be previously changed so as to cover the direction of the sound source and the distance thereof to calculate transfer characteristics H_{L} (I, α) and H_{R} (I, α). Then, the resulting transfer characteristics are stored in a transfer characteristic database in advance. Then, when the distance r, or the distance I illustrated in FIG. 6, is changed, transfer characteristics (for left and right ears) change, which lead to the minimum difference |1−r| between the sound source distances. The impulse characteristics corresponding to the resulting transfer characteristics are calculated and substituted in Equation (3) to change a sound source signal to give a sound source distance of r. Here, the calculation of the impulse characteristic corresponding to the transfer characteristic is performed by subjecting the transfer characteristic to a frequency-time conversion.

In order to change the direction of the sound source so as to be set to “θ”, for example, θ may be previously changed so as to cover the direction of the sound source and the distance thereof to calculate transfer characteristics H_{L} (I, α) and H_{R} (I, α). Then, the resulting transfer characteristics are stored in a transfer characteristic database in advance. Then, when the direction θ, or the direction α illustrated in FIG. 6, is changed, transfer characteristics (for left and right ears) change, which lead to the minimum difference |α−θ| between the sound source distances. The impulse characteristics corresponding to the resulting transfer characteristics are calculated and substituted in Equation (3) to change a sound source signal to give a sound source direction of θ.

By saving the transfer characteristic in the transfer characteristic database makes possible to change the distance and direction to output the guiding sound 22 as an output sound. Thus, the user U may be provided with a stereophonic sound having sound-source localization.

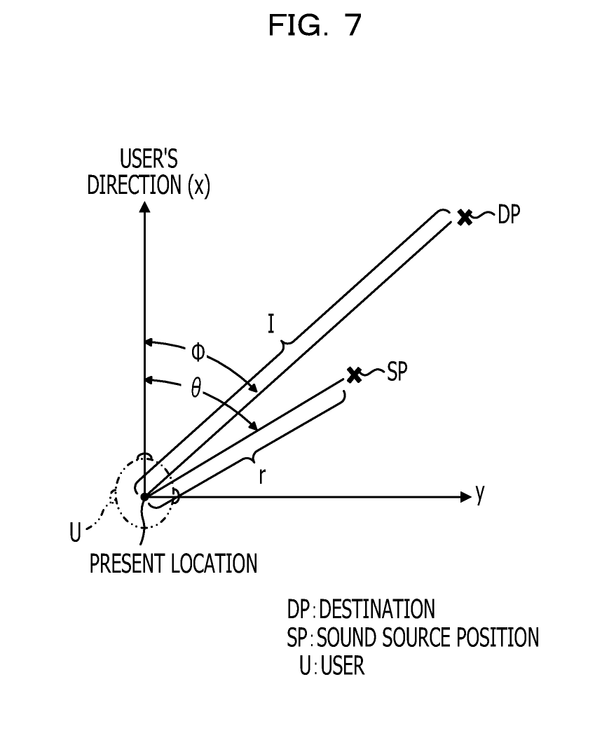

Next, with reference to FIG. 7, coordinates of the distance and direction of a sound source will be described. FIG. 7 is a diagram illustrating an exemplary positional relationship among a user, a destination, and a sound source. In addition, the positional relationship illustrated in FIG. 7 is for illustrative purpose only and is not intended to limit the scope of the invention. The same reference numerals denote the same structural components as those illustrated in FIG. 2.

Since the positional relationship between the destination and the user is the same as that of the first embodiment, it will be not described.

In an x-y coordinate plane illustrated in FIG. 7, a user is located on the origin on the x-y coordinate plane, where x=0 and y=0. In the x-y coordinate, a front direction of the user U is set as a positive direction along the x-axis. A right direction of the user U is set as a positive direction along a y axis. A sound source SP illustrated in FIG. 7 is located on the right side in the front direction of the user U. The sound source SP is a sound source of a stereophonic sound which is recognized by the user U by giving user U output sounds in_R (I, α, n) and in_L (I, α, n).

The position of the sound source illustrated in FIG. 7 is represented by (distance, angle)=(r, θ). A distance r between the user U and the sound source SP is defined as a linear distance from a user to a sound source, and a direction of the sound source to a user is represented by an angle θ. Since the distance r and the angle θ are a function of time t and represented by (r (t), θ (t)). Here, r (t) is a distance between a user and a sound source at time t and θ (t) is an angle of the user and the sound source at time t. In addition, an angle θ is defined as an angle between a front direction of the user U and a direction of the sound source from the user U. In other words, the angle is set to 0 (zero) at the front side of the user U and then measured in clockwise (right-handed) direction.

Next, for example, emphasis of the distance of the sound source is performed as follows.

The distance of the sound source is emphasized using, for example, a variation Δl (t) as a variation 18 in user's position with respect to the destination. For example, the emphasis on the distance of the sound source is independently performed on each of the following cases: Δl (t) is smaller than 0 (zero); Δl (t) is larger than 0 (zero); and Δl (t) is equal to 0 (zero), by controlling the distance r(t) of the sound source to vary the distance r(t) over time. The distance r(t) may be set by, for example, Equation (4) as follows.

$$\{ \begin{matrix}r ( t ) = f 1 ( t ) ( {R}_{max} - {R}_{min} ) + {R}_{min} & Δ l ( t ) < 0 \\ r ( t ) = f 2 ( t ) ( {R}_{max} - {R}_{min} ) + {R}_{min} & Δ l ( t ) > 0 \\ r ( t ) = R ( l ( t ) ) & Δ l ( t ) = 0\end{matrix} \qquad ( 4 )$$

In the equation, f1 (t) is a function that repeats monotone decreasing periodically; f2 (t) is a function that repeats monotone increasing periodically; R is a function of I; Rmax is a Maximum value of R, for example, which is set to 100 (m); and Rmin is a Minimum value of R, for example, which is set to 1 (m). Here, (m) represents a unit of distance, “meter”.

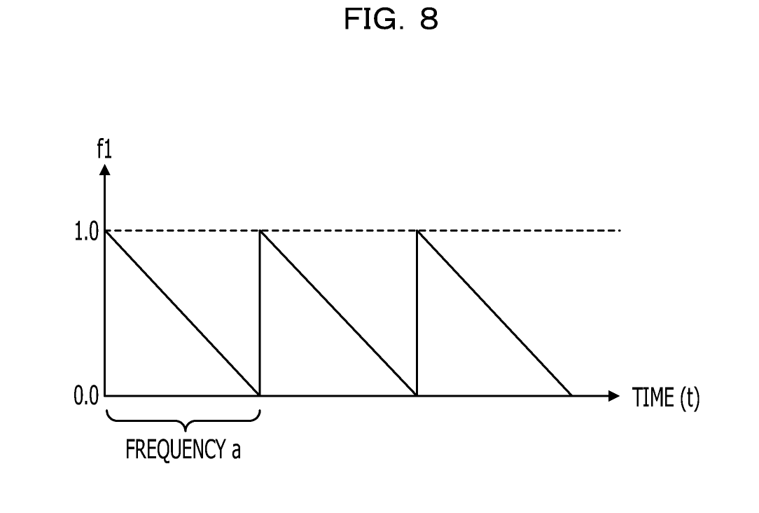

Function f1 (t), which repeats monotone decreasing periodically, may be represented by a saw-tooth wave as illustrated in FIG. 8. The saw-tooth wave illustrated in FIG. 8 is a function of linearly decreasing from numerical value 1 with time and, when reaching 0 (zero), rapidly increasing to numerical value 1. This kind of numerical change is repeated at a predetermined cycle “a”. The saw-tooth wave illustrated in FIG. 8 is represented by Equation (5) as follows.

$$f 1 ( t ) = ( \frac{t}{a} - floor ( \frac{t}{a} ) ) \qquad ( 5 )$$

However, floor (t) is a floor function, and “a” is a cycle of function f1 (t).

When Equation (5) is used as f1 (t) and Δl (t) is smaller than 0 (zero), the sound source SP linearly moves toward the user U from distance Rmax to distance Rmin with time. When the sound source SP approaches the distance Rmin, a stereophonic sound rapidly moves away to distance Rmax. Then, stereophonic sounds may be repeatedly given at cycle “a”.

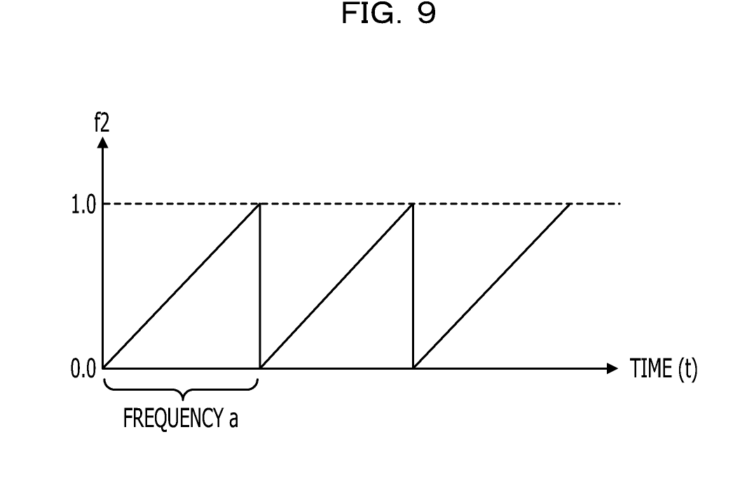

Function f2 (t), which repeats a monotone increase periodically, may be represented by a saw-tooth wave illustrated in FIG. 9. The saw-tooth wave illustrated in FIG. 9 is a function of linearly increasing from numerical value 0 (zero) with time and, when reaching 1 (one), rapidly decreases to numerical value 0 (zero). This kind of numerical change is repeated at a predetermined cycle “a”. The saw-tooth wave illustrated in FIG. 9 is represented by Equation (6) as follows.

$$f 2 ( t ) = 1.0 - ( \frac{t}{a} - floor ( \frac{t}{a} ) ) \qquad ( 6 )$$

When Equation (6) is used as f2 (t) and Δl (t) exceeds 0 (zero), the sound source SP linearly moves away from the user U from distance Rmin to distance Rmax with time. When the sound source SP moves away to the distance Rmax, a stereophonic sound rapidly moves close to distance Rmin. Then, stereophonic sounds may be repeatedly given at cycle “a”.

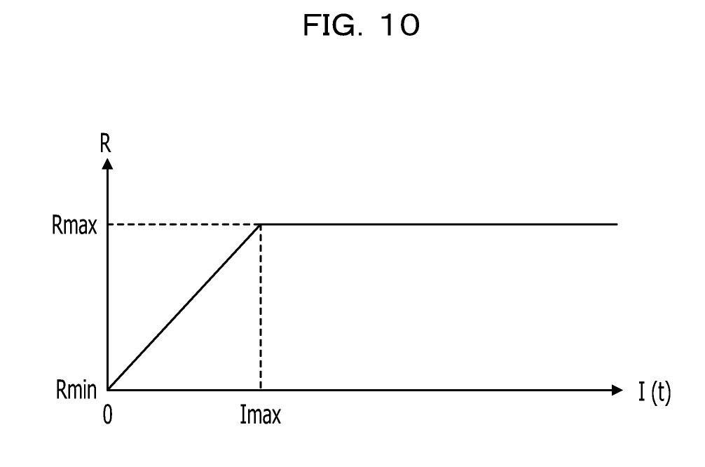

When Δl (t) is 0 (zero) and variation 18 in user's position with respect to the destination is 0 (zero), for example, r (t) is set to function R (l(t)) as illustrated in FIG. 10. Function R (l(t)) illustrated in FIG. 10 is a function using a distance l(t) at time t and R representing a distance on a stereophonic sound as axes. Function R (l(t)) is represented by (l(t), R), including a region defined by linearly connecting between a point (0, Rmin) and a point (Imax, Rmax) and a region where R=Rmax. When distance l(t) is 0 (zero), the function R (l(t)) represents the presence of the user U at a destination and is set to R=Rmin. The value of R increases linearly as the distance l(t) becomes larger than 0 (zero). Thus, the distance l(t) becomes Imax and R reaches the maximum value (Rmax). When the distance is equal to or more than Imax, R is set to a constant value as R=Rmax. In the function R(l(t)) illustrated in FIG. 10, r(t) is set to a value in proportion to the distance l(t) when the distance l(t) is in a range of 0 (zero) to Imax. When the distance l(t) is Imax or more, r(t) is set to Rmax. By setting up in this way, when Δl (t) does not change, it can be set to a sound-source attribute according to the distance l (t).

Thus, the function r(t) is changed according to Δl (t) as a variation 18 in user's position with respect to the destination. The sound-source attribute of distance may be changed and the sound-source attribute of distance may be emphasized.

Next, in processing for generating a destination guidance sound 22 from the variation in user's position with respect to the destination, for example, processing for emphasizing a sound-source attribute (Step S1 in FIG. 3) and processing for applying an emphasized sound-source attribute (Step S2 in FIG. 3) are performed. The sound-source attribute emphasis unit 32 performs the processing for emphasizing a sound-source attribute, and the sound-source attribute application unit 36 performs the processing for applying an emphasized sound-source attribute 20.

(1) Processing for Emphasizing a Sound-Source Attribute

As a variation 18 in user's position with respect to the destination, a variation Δl (t) of the distance is input in the sound-source attribute emphasis unit 32, and “distance” is input in the sound-source attribute emphasis unit 32 as a sound-source attribute 16. The distance emphasis unit 34 of the sound-source attribute emphasis unit 32 calculate r (t) according to a variation Δl (t) of the distance. Then, the sound-source attribute 16 of distance is emphasized. Subsequently, the sound-source attribute emphasis unit 32 outputs an emphasized sound-source attribute 20 of the distance according to r (t). Then the sound-source attribute 20 of the emphasized distance is input in the sound-source attribute application unit 36.

(2) Processing for Application of Emphasized Sound-Source Attribute

When the sound-source attribute 20 of the emphasized distance and the sound source 10 are input in the sound-source attribute application unit 36, the distance application unit 38 of the sound-source attribute application unit 36 replaces an attribute of the sound source 10 with the sound-source attribute 20 of the emphasized distance, calculates and outputs, a destination guidance sound 22. That is, the distance application unit 38 receives function information of r (t) as an emphasized sound-source attribute 20 of the distance. Right-ear output sound in_R (I, α, n) and left-year output sound in_L (I, α, n), which are illustrated in Equation (3), are generated to set the sound source distance to r (t). The distance application unit 38 outputs the right-ear output sound in_R (I, α, n) and the left-year output sound in_L (I, α, n), as a destination guidance sound 22. When the user U hears the right-ear output sound in_R (I, α, n) and the left-year output sound in_L (I, α, n), the user U obtains a stereophonic sound from the sound source, which changes according to r (t). Then, the user U is allowed to easily recognize a variation Δl (t) of the distance from a displacement of the sound source.

According to the positional variation of the user U, the sound-source attribute emphasis unit 32 controls the distance of a sound-source attribute so that the distance of the sound-source attribute may become smaller when the user U approaches the destination direction and the distance of the sound-source attribute may become farther when the user U moves away from the destination direction. By controlling the distance of the sound-source attribute, it becomes easy to perceive the sound source and the sound source becomes clear. Therefore, the user may sense intuitively that the user has approached the destination or moved away therefrom. Therefore, compared with a case where a sound source on a stereophonic sound is oriented on a fixed distance depending only on a distance, the destination is easily recognizable and the user U may be easily guided thereto.

### Third Embodiment

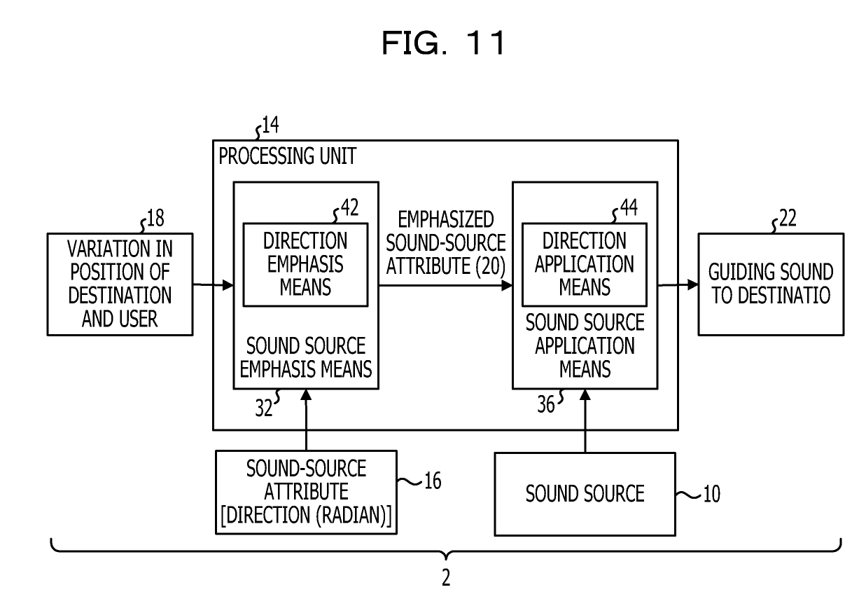

Referring now to FIG. 11, a third embodiment will be described. FIG. 11 is a diagram illustrating an exemplary guiding sound generating apparatus according to the third embodiment. The configuration of the guiding sound generating apparatus illustrated in FIG. 11 is for illustrative purpose only and is not intended to limit the scope of the invention. In FIG. 11, the same reference numerals denote the same structural components as those illustrated in FIGS. 1, 4, and 5.

According to this embodiment, a sound source with an emphasized attribute is output through a sound-source attribute emphasis unit 32 and a sound-source attribute application unit 36 and guides a user intelligibly to a destination. Since both the sound-source attribute emphasis unit 32 and the sound-source attribute application unit 36 have the same configurations as those of the second embodiment, the description thereof will be omitted hereinafter.

When emphasizing a sound source 10 using a sound-source attribute 16, such as direction information, the sound-source attribute emphasis unit 32 illustrated in FIG. 11 receives specification of a “direction” as sound-source attribute 16. In addition, the sound-source attribute emphasis unit 32 receives a variation 18 in user's position with respect to a destination. Then, the sound-source attribute emphasis unit 32 emphasizes and outputs a direction between the destination and the present location according to the received information. The information about the direction between the destination and the present location is an exemplary sound-source attribute 16. The sound-source attribute emphasis unit 32 is provided with a direction emphasis unit 42 as a unit for emphasizing the direction between the destination and the present location.

The sound-source attribute application unit 36 illustrated in FIG. 11 has a direction application unit 44 as a unit for generating a destination guidance sound 22 by applying a sound-source attribute 20, which is information about the emphasized direction, to the sound source 10.

The direction emphasis unit 42 controls the guiding sound 22 to be input in user's ears to make the user recognize a stereophonic sound. Then, the user acquires a physical feeling of hearing a sound from a sound source set in a three-dimensionally extending region. Therefore, a distance and a direction may be set between the user and the sound source. Since a relationship between a distance and a direction of a sound source and expressions about the distance and the direction using the sound source are the same as those of the second embodiment, the description thereof will be omitted hereinafter.

Next, for example, emphasis on the direction of the sound source is performed as follows.

The direction of the sound source is emphasized using, for example, a variation ΔΩ (t) as a variation 18 in user's position with respect to the destination. For example, the emphasis on an angle of the sound source is independently performed on each of the following cases: ΔΩ (t) is smaller than 0 (zero); ΔΩ (t) is larger than 0 (zero); and ΔΩ (t) is equal to 0 (zero), by controlling the direction θ (t) of the sound source to vary the direction θ (t) over time. The direction θ (t) may be set by, for example, Equation (7) as follows.

$$\{ \begin{matrix}θ ( t ) = f 1 ( t ) ( {Θ}_{max} - {Θ}_{min} ) + {Θ}_{min} & ΔΦ ( t ) < 0 \\ θ ( t ) = f 2 ( t ) ( {Θ}_{max} - {Θ}_{min} ) + {Θ}_{min} & ΔΦ ( t ) > 0 \\ θ ( t ) = Φ ( t ) & ΔΦ ( t ) = 0\end{matrix} \qquad ( 7 )$$

In the equation, Θmax is a Maximum value of Θ, for example, which is set to ¼Π(radian), and Θmin is a Minimum value of Θ, for example, which is set to 0 (zero) (radian). Here, the (radian) represents a unit of an angle. Since both f1 (t) and f2 (t) are the same as those of the second embodiment, the description thereof will be omitted hereinafter.

In the case where Equation (5) is used as f1 (t) and ΔΩ (t) is smaller than 0 (zero), when the sound source moves with respect to the front side of the user U from the angle Θmax to the angle Θmin, for example, by moving toward the front side of the user U, and the sound source moves to the angle Θmin, the sound source may rapidly provide the front side of the user U with a stereophonic sound which moves to the angle Θmax. Then, such a kind of stereophonic sounds may be repeatedly given at cycle “a”.

When using Equation (6) as f2 (t), in the case where ΔΩ (t) exceeds 0 (zero), when the sound source moves with respect to the front side of the user U from the angle Θmin to the angle Θmax, for example, by moving toward the front side of the user U, and the sound source moves to the angle Θmax, the sound source may rapidly provide the front side of the user U with a stereophonic sound which moves to the angle Θmin. Then, stereophonic sounds may be repeatedly given at cycle “a”.

When ΔΩ (t) is 0 (zero) and variation 18 in user's position with respect to the destination is 0 (zero), for example, θ (t) is set to Φ (t). Therefore, in this setting, the sound source of a stereophonic sound is set in the direction of the destination when the ΔΩ (t) does not change. Thus, the user U hears a sound from the direction of the destination.

Thus, the function θ (t) is changed according to ΔΩ (t) as a variation 18 in user's position with respect to the destination. The sound-source attribute of direction may be changed and the sound-source attribute of direction may be emphasized.

Next, in processing for generating a destination guidance sound 22 from the variation in user's position with respect to the destination, for example, processing for emphasizing a sound-source attribute (Step S1 in FIG. 3) and processing for applying an emphasized sound-source attribute (Step S2 in FIG. 3) are performed.

(1) Processing for Emphasizing a Sound-Source Attribute

As a variation 18 in user's position with respect to the destination, a variation ΔΦ (t) of angle is input in the sound-source attribute emphasis unit 32, and “distance” is input in the sound-source attribute emphasis unit 32 as a sound-source attribute 16 and “direction” is input in the sound-source attribute emphasis unit 32 as a sound-source attribute 16. The direction emphasis unit 42 of the sound-source attribute emphasis unit 32 calculates θ (t) according to a variation ΔΩ (t) of the distance. Then, the sound-source attribute 16 of distance is emphasized. Subsequently, the sound-source attribute emphasis unit 32 outputs an emphasized sound-source attribute 20 of the direction according to θ (t). Then the sound-source attribute 20 of the emphasized direction is input in the sound-source attribute application unit 36.

(2) Processing for Application of Emphasized Sound-Source Attribute

When the sound-source attribute 20 of the emphasized direction and the sound source 10 are input in the sound-source attribute application unit 36, the direction application unit 44 of the sound-source attribute application unit 36 replaces an attribute of the sound source 10 with the sound-source attribute 20 of the emphasized direction, calculates and outputs a destination guidance sound 22. That is, the direction application unit 44 receives function information of θ (t) as a source attribute of the distance. Right-ear output sound in_R (I, α, n) and left-ear output sound in_L (I, α, n), which are illustrated in Equation (3), are generated to set the sound source direction to θ (t). The direction application unit 44 outputs the right-ear output sound in_R (I, α, n) and the left-ear output sound in_L (I, α, n), as a destination guidance sound 22. The user U hears the right-ear output sound in_R (I, α, n) and the left-ear output sound in_L (I, α, n). The user U obtains a stereophonic sound which is varied with θ (t) and which is heard from a certain direction. From the displacement or fixedness of the sound source, the user U may easily grasp a variation ΔΦ (t) in angle.

According to the positional variation of the user U, the sound-source attribute emphasis unit 32 controls the angle of a sound-source attribute so that the angle of the sound-source attribute may become smaller when the user U approaches the destination direction and the angle of the sound-source attribute may become larger when the user U moves away from the destination direction. By controlling the angle of the sound-source attribute, it becomes easy to perceive the sound source and the sound source becomes clear. Therefore, when the amount of change increases, the angle of the sound-source attribute may be changed so that it becomes larger than the change of the actual angle between the user and the destination. For example, as compared with a sound source which is only oriented in the direction of an angle equal to the angle between the user and the destination, the user U may be more intelligibly guided to the destination.

### Fourth Embodiment

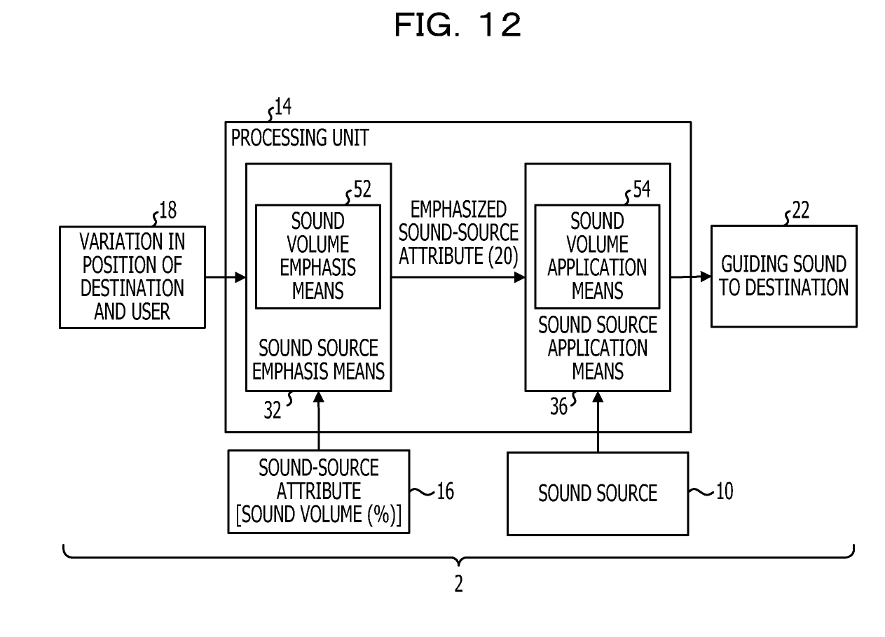

Referring now to FIG. 12, a fourth embodiment will be described. FIG. 12 is a diagram illustrating an exemplary guiding sound generating apparatus according to a fourth embodiment. The configuration of the guiding sound generating apparatus illustrated in FIG. 12 is for illustrative purpose only and is not intended to limit the scope of the invention. In FIG. 11, the same reference numerals denote the same structural components as those illustrated in FIGS. 1, 4, 5, and 11.

According to this embodiment, a sound source with an emphasized attribute is output through a sound-source attribute emphasis unit 32 and a sound-source attribute application unit 36 so as to guide a user intelligibly to a destination. Since both the sound-source attribute emphasis unit 32 and the sound-source attribute application unit 36 have the same configurations as those of the second embodiment, the description thereof will be omitted.

In a case of emphasizing the sound source 10 when sound volume information is used as an exemplary sound-source attribute 16, the sound-source attribute emphasis unit 32 illustrated in FIG. 12 receives specification of “sound volume” as the sound-source attribute 16. In addition, the sound-source attribute emphasis unit 32 receives a variation 18 in user's position with respect to a destination. Then, the sound-source attribute emphasis unit 32 provides a sound-source attribute of the sound volume with a variation to emphasize the sound-source attribution of the sound volume. The sound-source attribute emphasis unit 32 is provided with a sound-volume emphasis unit 52 as a unit for emphasizing the distance and direction between the destination and the present location.

The sound-source attribute application unit 36 illustrated in FIG. 12 has a sound-volume application unit 54 as a unit for generating a destination guidance sound 22 by applying a sound-source attribute 20, which is information about the emphasized sound volume, to the sound source 10.

Next, in the emphasis using a sound volume, based on a user's positional variation with respect to a destination (variation 18 in user's position with respect to the destination), for example, a destination guidance sound 22 is generated and this destination guidance sound 22 is presented to a user U. A magnification ratio v(%) of a sound volume of a sound source to be presented to the user U is defined using, for example, Equations (8), (9), and (10). Here, the magnification ratio v(%) is a percentage of the sound volume to that of the original sound source 10. Thus, a value v is a sound volume when the sound volume of the original sound source 10 is defined as 100.

$$\begin{matrix}v ( Δ 1 ( t ) , ΔΦ ( t ) ) = coeff\_v * v 1 ( Δ1 ( t ) ) + ( 1 - coeff\_v ) v 2 ( ΔΦ ( t ) ) & ( 8 ) \\ \{ \begin{matrix}v 1 ( t ) = f 1 ( t ) ( {V}_{max} - {V}_{min} ) + {V}_{min} & Δ l ( t ) < 0 \\ v 1 ( t ) = f 2 ( t ) ( {V}_{max} - {V}_{min} ) + {V}_{min} & Δ l ( t ) > 0 \\ v 1 ( t ) = 1.0 & Δ l ( t ) = 0\end{matrix} & ( 9 ) \\ \{ \begin{matrix}v 2 ( t ) = f 1 ( t ) ( {V}_{max} - {V}_{min} ) + {V}_{min} & ΔΦ ( t ) < 0 \\ v 2 ( t ) = f 2 ( t ) ( {V}_{max} - {V}_{min} ) + {V}_{min} & ΔΦ ( t ) > 0 \\ v 2 ( t ) = 1.0 & ΔΦ ( t ) = 0\end{matrix} & ( 10 )\end{matrix}$$

In these equations, “Vmax” represents the maximum value of V, for example, which is set to 3; “Vmin” represents the minimum value of v, for example, which is set to 0.1; and “coeff_v” represents contribution of v1 is expressed and set to a value within a range of 0 to 1.

Since both f1 (t) and f2 (t) are the same as those of the second embodiment, the description thereof will be omitted hereinafter.

A value of v1 (t) represents emphasis on distance. When Equation (5) is used as f1 (t) and Δl (t) is smaller than 0 (zero), the value of v1(t) is linearly decreased from Vmax to Vmin with time. When a value is decreased to Vmin, then the value is increased to Vmax rapidly. Then, such a variation in value may be repeatedly given at cycle “a”. When Equation (6) is used as f2 (t) and Δl (t) exceeds 0 (zero), the value of v1(t) is linearly from Vmin to Vmax with time. When a value increases to Vmax, then the value decreases to Vmin rapidly. Then, such a variation in value may be repeatedly given at cycle “a”. When Δl (t) is 0 (zero) and variation 18 in user's position with respect to the destination is 0 (zero), v1(t) is set to 1.0. Thus, the function v1(t) is changed according to Δl (t) as a variation 18 in user's position with respect to the destination. The distance can be emphasized using a sound volume.

A value of v2 (t) represents emphasis on direction. When Equation (5) is used as f1 (t) and ΔΦ (t) is smaller than 0 (zero), the value of v2(t) is linearly decreased from Vmax to Vmin with time. When a value is decreased to Vmin, the value is increased to Vmax rapidly. Then, such a variation in value may be repeatedly given at cycle “a”. When Equation (6) is used as f2 (t) and ΔΦ (t) exceeds 0 (zero), the value of v2(t) is linearly increased from Vmin to Vmax with time. When a value increases to Vmax, then the value decreases to Vmin rapidly. Then, such a variation in value may be repeatedly given at cycle “a”. When ΔΦ (t) is 0 (zero) and variation 18 in user's position with respect to the destination is 0 (zero), v2(t) is set to 1.0. Thus, the function v2(t) is changed according to Δl (t) as a variation 18 in user's position with respect to the destination. The direction can be emphasized using a sound volume.

In v (Δl (t), ΔΦ (t)), a value v1(t) representing emphasis on distance and a value v2(t) representing emphasis on direction are multiplied by a coefficient coeff_v and a coefficient (1−coeff_v), followed by addition of v1 (t) and v2 (t). Thus, v (Δl (t), ΔΦ (t)) allows emphasis on distance and direction. Both the distance and the direction may be emphasized when a sound source is emphasized by v (Δl (t), ΔΦ (t)). When coeff_v is set in a range of 0 to less than 0.5, v (Δl (t), ΔΦ (t)) emphasizes the direction rather than the distance. When coeff_v is set in a range of more than 0.5 to 1, v (Δl (t), ΔΦ (t)) emphasizes the distance rather than the direction. When coeff_v is set to 0.5, v (Δl (t), ΔΦ (t)) emphasizes the distance and the direction equally. When coeff_v is set to zero, v (Δl (t), ΔΦ (t)) is set to emphasize the direction. When coeff_v is set to 1 (one), v (Δl (t), ΔΦ (t)) is set to emphasize the distance rather than the direction. In this way, since Equation (8) representing v (Δl (t), ΔΦ (t)) includes coefficients coeff_v and (1−coeff_v), it is possible to set a rate of emphasizing the direction and the distance as a specified value or an arbitrarily value. Flexibility of selecting degrees of emphasizing the distance and the direction is enhanced.

Next, in processing for generating a destination guidance sound 22 from the variation in user's position with respect to the destination, for example, processing for emphasizing a sound-source attribute (Step S1 in FIG. 3) and processing for applying an emphasized sound-source attribute (Step S2 in FIG. 3) are performed.

(1) Processing for Emphasizing a Sound-Source Attribute

As a variation 18 in user's position with respect to the destination, a variation Δl (t) of distance and a variation ΔΩ (t) of angle are input in the sound-source attribute emphasis unit 32, and a “sound volume” is input in the sound-source attribute emphasis unit 32 as a sound-source attribute 16. The sound-volume emphasis unit 52 of the sound-source attribute emphasis unit 32 changes a volume sound-source attribute by calculating v1 (t) according to a variation Δl (t) of distance to emphasize the distance. The sound-volume emphasis unit 52 of the sound-source attribute emphasis unit 32 calculates v2(t) according to a variation ΔΩ (t) in angle to change a sound-source attribute of a sound volume, thereby emphasizing the direction. The sound-volume emphasis unit 52 calculates v(Δl (t), ΔΦ (t))) using v1(t) and v2(t) to obtain v(Δl (t), ΔΦ (t)), thereby emphasizing the distance and the direction. Thus, a sound-source attribute is emphasized by the sound-volume emphasis unit 52.

The sound-source attribute emphasis unit 32 outputs v (Δl (t), ΔΦ (t)) as a sound-source attribute 20 of the emphasized volume. The sound-source attribute 20 of the emphasized volume is input in the sound-source attribute application unit 36.

(2) Processing for Application of Emphasized Sound-Source Attribute

When a sound-source attribute 20 of an emphasized sound amount and a sound source 10 are input into the sound-source attribute application unit 36, the sound-volume application unit 54 of sound-source attribute application unit 36 changes a signal of the sound source 10 using the input value v (Δl (t), ΔΦ (t)). This change of the sound source 10 may be performed by, for example, Equation (11). Thus, the sound-source 10 signal sample es(t) with an emphasized volume is changed so that it may be multiplied by v (Δl (t), ΔΦ (t)) (%).

es(t)=s(t)×v/100 (11)

In this equation, “v” represents a value obtained by calculation with Equation (8), i.e., v, (Δl (t), ΔΦ (t)); “s(t)” represents a sound-source signal sample of sound source 10; and “es (t)” represents a sample of a sound source signal with an emphasized sound volume.

Thus, the sound volume of sound source 10 is changed. Therefore, from the displacement or fixedness of the sound volume of the sound source, the user U may easily grasp a variation Δl (t) in distance and a variation ΔΩ (t) in angle. The sound-course attribute emphasis unit 32 controls the sound volume so that the sound volume of the sound source becomes larger as long as the user U approaches to the destination direction according to a variation amount of a position of the user U. The sound volume of the sound source is set to become lower when the user moves away from the destination direction. When the sound volume of the sound source becomes larger, it may become easy to perceive the sound source and the sound source may become clearer. Since the sound volume may be changed according to a change in actual distance between the user U and the destination, as compared with, for example, one that presents a sound source with a fixed volume, the user U may be more intelligibly guided to the destination.

### Fifth Embodiment

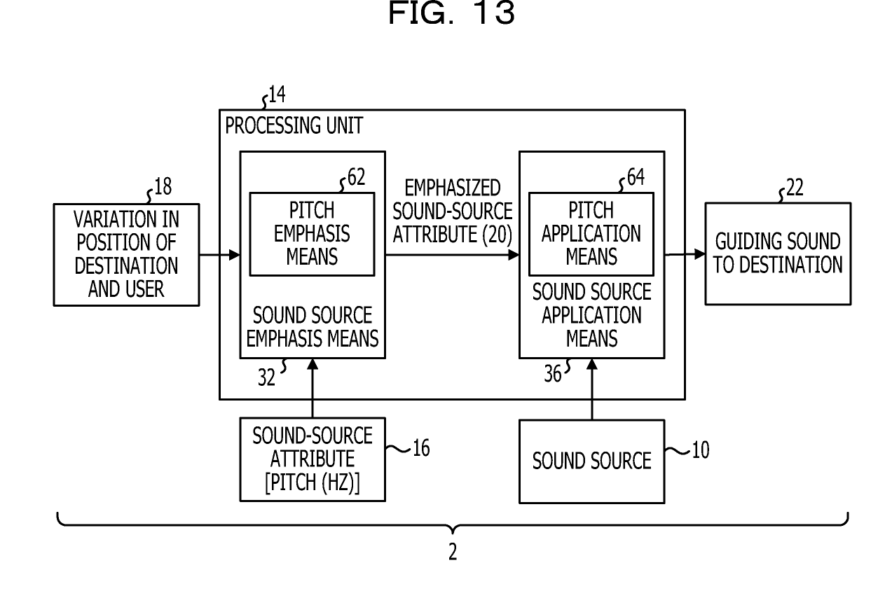

A fifth embodiment will be described with reference to FIG. 13. FIG. 13 is a diagram illustrating an exemplary guiding sound generating apparatus according to the fifth embodiment. The configuration of the guiding sound generating apparatus illustrated in FIG. 13 is for illustrative purpose only and is not intended to limit the scope of the invention. In FIG. 13, the same reference numerals denote the same structural components as those illustrated in FIGS. 1, 4, 5, 11, and 12.

According to this embodiment, a sound source with an emphasized attribute is output through a sound-source attribute emphasis unit 32 and a sound-source attribute application unit 36 and guides a user intelligibly to a destination. Since both the sound-source attribute emphasis unit 32 and the sound-source attribute application unit 36 have the same configurations as those of the second embodiment, the description thereof will be omitted hereinafter.

In a case of emphasizing the sound source when pitch information is used as an exemplary sound-source attribute 16, the sound-source attribute emphasis unit 32 illustrated in FIG. 13 receives specification of “pitch” as the sound-source attribute 16. In addition, the sound-source attribute emphasis unit 32 receives a variation 18 in user's position with respect to a destination. Then, the sound-source attribute emphasis unit 32 provides a sound-source attribute of the pitch with a variation to emphasize the sound-source attribution of the pitch. The sound-source attribute emphasis unit 32 is provided with a pitch emphasis unit 62 as a unit that utilizes a pitch to emphasize the distance and direction between the destination and the present location.

The sound-source attribute application unit 36 illustrated in FIG. 13 has a pitch application unit 64 as a unit for generating a destination guidance sound 22 by applying a sound-source attribute 20, which is information about the emphasized pitch, to the sound source 10.

Next, in the emphasis using a pitch, for example, based on a user's positional variation with respective to a destination (variation 18 in user's position with respect to the destination), a destination guidance sound 22 is generated and this destination guidance sound 22 is presented to a user U. A controlled variable p of a sound source pitch presented to the user U is determined, for example using Equation (12), Equation (13), and Equation (14). Here, the controlled variable p is a pitch variation with respect to the pitch of the original sound source 10. When the value p becomes large, it means that the amount of change of the pitch becomes large.

$$\begin{matrix}p ( Δ 1 ( t ) , ΔΦ ( t ) ) = coeff\_p * p 1 ( Δ1 ( t ) ) + ( 1 - coeff\_p ) p 2 ( ΔΦ ( t ) ) & ( 12 ) \\ \{ \begin{matrix}p 1 ( t ) = f 1 ( t ) ( {P}_{max} - {P}_{min} ) + {P}_{min} & Δ l ( t ) < 0 \\ p 1 ( t ) = f 2 ( t ) ( {P}_{max} - {P}_{min} ) + {P}_{min} & Δ l ( t ) > 0 \\ p 1 ( t ) = 1.0 & Δ l ( t ) = 0\end{matrix} & ( 13 ) \\ \{ \begin{matrix}p 2 ( t ) = f 1 ( t ) ( {P}_{max} - {P}_{min} ) + {P}_{min} & ΔΦ ( t ) < 0 \\ p2 ( t ) = f 2 ( t ) ( {P}_{max} - {P}_{min} ) + {P}_{min} & ΔΦ ( t ) > 0 \\ p 2 ( t ) = 1.0 & ΔΦ ( t ) = 0\end{matrix} & ( 14 )\end{matrix}$$

In the equations “Pmax” represents the maximum value of p, for example, which is set to 2; “Pmin” represents the minimum value of p, for example, which is set to 0.5; and “coeff_p” represents contribution of p1 and is set to a value in a range of 0 to 1.

Since both f1 (t) and f2 (t) are the same as those of the second embodiment, the description thereof will be omitted hereinafter.

Here, p1 (t) expresses emphasis of distance. When a formula (5) is used as f1 (t) and Δl (t) is smaller than 0 (zero), a value of p1 (t) linearly decreases from Pmax to Pmin with time. When the value is decreased to Pmin, then the value is rapidly increased to Pmax. Then, such a variation in value may be repeatedly given at cycle “a”. When a formula (6) is used as f2 (t) and Δl (t) exceeds 0 (zero), a value of p2 (t) linearly increases from Pmin to Pmax with time. When a value rises to Pmax, a value will decrease to Pmin rapidly. Then, such a variation in value may be repeatedly given at cycle “a”. When Δl (t) is 0 (zero) and variation 18 in user's position with respect to the destination is 0 (zero), p1 (t) is set to 1.0. Thus, the function p1 (t) is changed according to Δl (t) as a variation 18 in user's position with respect to the destination. The distance can be emphasized using a pitch.

A value of p2 (t) represents emphasis on direction. When a formula (5) is used as f1 (t) and ΔΩ (t) is smaller than zero, a value of p2 (t) linearly decreases from Pmax to Pmin with time. When the value is decreased to Pmin, then the value is rapidly increased to Pmax. Then, such a variation in value may be repeatedly given at cycle “a”. When Equation (6) is used as f2 (t) and ΔΩ (t) exceeds 0 (zero), the value of p2 (t) is linearly increased from Pmin to Pmax with time. When a value rises to Pmax, a value will decrease to Pmin rapidly. Then, such a variation in value may be repeatedly given at cycle “a”. When ΔΩ (t) is 0 (zero) and variation 18 in user's position with respect to the destination is 0 (zero), p2 (t) is set to a fixed value of 1.0. Thus, the function p2 (t) is changed according to ΔΩ (t) as a variation 18 in user's position with respect to the destination. The direction can be emphasized using a pitch.

In p (Δl (t), ΔΦ (t)), a value v1(t) representing emphasis on distance and a value p2 (t) representing emphasis on direction are multiplied by a coefficient coeff_p and a coefficient (1−coeff_p), followed by addition of p1 (t) and p2 (t). Thus, p (Δl (t), ΔΦ (t)) allows emphasis on distance and direction. Both the distance and the direction may be emphasized when a sound source is emphasized by p (Δl (t), ΔΦ (t)). When coeff_p is set in a range of 0 to less than 0.5, p (Δl (t), ΔΦ (t)) emphasizes the direction rather than the distance. When coeff_p is set in a range of more than 0.5 to 1, p (Δl (t), ΔΦ (t)) emphasizes the distance rather than the direction. When coeff_p is set to 0.5, p (Δl (t), ΔΦ (t)) emphasizes the distance and the direction equally. When coeff_p is set to zero, p (Δl (t), ΔΦ (t)) is set to emphasize the direction. When coeff_p is set to 1 (one), p (Δl (t), ΔΦ (t)) is set to emphasize the distance rather than the direction. In this way, since Equation (12) representing p (Δl (t), ΔΦ (t)) includes coefficients coeff_p and (1−coeff_p), it is possible to set a rate of emphasizing the direction and the distance as a specified value or an arbitrarily value. Flexibility of selecting degrees of emphasizing the distance and the direction is enhanced.

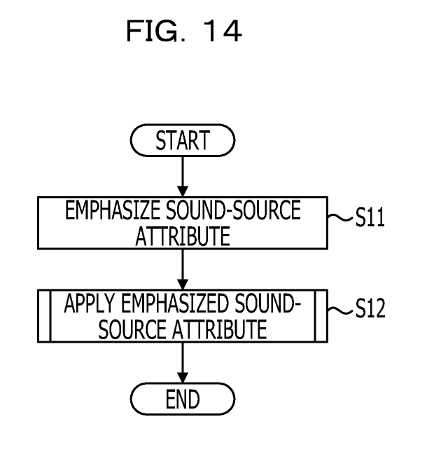

Next, FIG. 14 is referred to describe a process for generating a guiding sound. FIG. 14 is a flowchart illustrating an exemplary process for generating a guiding sound. The process for generating the guiding sound is an example of the guiding sound generating program of the present disclosure which is illustrative purpose only and is not intended to limit the scope of the invention.

In procedures illustrated in FIG. 14, processing for emphasizing a sound-source attribute (Step S11) and processing for applying an emphasized sound-source attribute (Step S12) are performed. These procedures are performed by the sound-source attribute emphasis unit 32 and the sound-source attribute application unit 36.

(1) Processing for Emphasizing a Sound-Source Attribute

As a variation 18 in user's position with respect to the destination, a variation Δl (t) of distance and a variation ΔΩ (t) of angle are input in the sound-source attribute emphasis unit 32, and a “pitch” is input in the sound-source attribute emphasis unit 32 as a sound-source attribute 16. The pitch emphasis unit 62 of the sound-source attribute emphasis unit 32 changes a pitch sound-source attribute by calculating p1 (t) according to a variation Δl (t) of distance to emphasize the distance. The pitch emphasis unit 62 calculates p2 (t) according to a variation ΔΩ (t) of the angle to change the pitch sound-source attribute, thereby emphasizing the direction. Using p1 (t) and p2 (t), the pitch emphasis unit 62 calculates p (Δl (t), ΔΦ (t)), and emphasizes both distance and direction. Thus, a sound-source attribute is emphasized by the pitch emphasis unit 62.

The sound-source attribute emphasis unit 32 outputs p (Δl (t), ΔΦ (t)) as a sound-source attribute 20 of the emphasized pitch. The sound-source attribute 20 of the emphasized pitch is input in the sound-source attribute application unit 36.

(2) Processing for Application of Emphasized Sound-Source Attribute

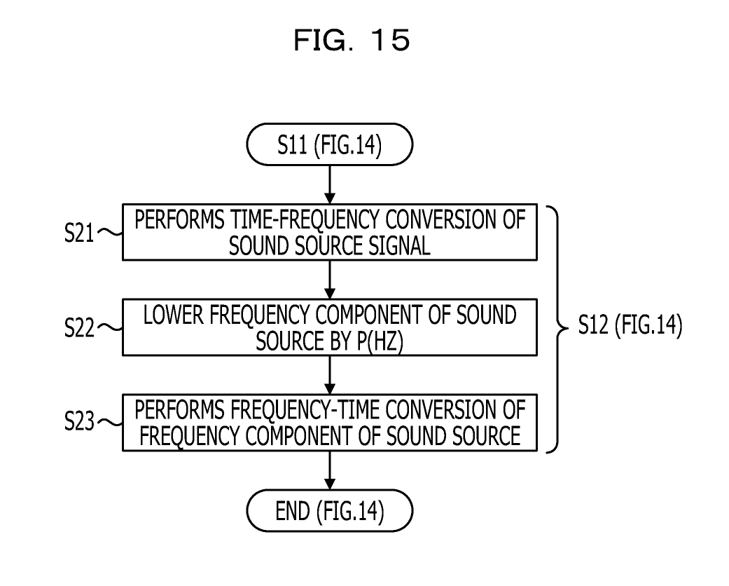

FIG. 15 is referenced for describing processing for application of emphasized sound-source attribute. FIG. 15 is a flowchart illustrating an exemplary process for application of a sound-source attribute of a pitch. The processing illustrated in FIG. 15 is for illustrative purpose only and is not intended to limit the scope of the invention. Procedures of processing for application of a pitch sound-source attribute illustrated in FIG. 15 is a subroutine of processing for application of emphasized sound-source attribute (Step S12) illustrated in FIG. 14.

When a sound-source attribute 20 of an emphasized pitch and a sound source 10 are input in the sound-source attribute application unit 36, the pitch application unit 64 of the sound-source attribute application unit 36 performs a time-frequency conversion of a sound source signal of the sound source 10 to obtain a frequency component S (Step S21). This time-frequency conversion divides a sound source signal into N frequency bands and then calculates a frequency component S for each frequency band. The frequency component is a complex number for every frequency (unit: Hz). The frequency component of a K-th frequency band is represented by, for example, S(k). When a sound source signal is divided into N frequency bands, for example, the division may be performed so that the widths of the respective frequency bands may be equal to one another. By dividing the frequency band in this way, management of bandwidths may be easily performed. Here, “k” is an integer in a range of 0 to N−1 and represents a divided band number.

Next, using the emphasized pitch sound-source attribute 20, the frequency component of the sound source is lowered by p (Hz) (Step S22) to change the frequency component of the sound source. Here, using p (Δl (t), ΔΦ (t)), which is obtained as a controlled variable p which is a value used for lowering the frequency component, a moving number j of the frequency bands moved is calculated from Equation (15).

j=round(p/Δf) (15)

In the equation, “Δf” is a value {f(k)−f (k−1)} obtained by subtracting (k−1)-th frequency f (k−1) from k-th frequency f(k) and represents a bandwidth of a frequency component; and “round( )” is a function that outputs an integer by rounding to the number of decimal places.

When the frequency bandwidth of each frequency component is set to Δf, a bandwidth corresponding to j components is p (Hz) or nearly p (Hz). Then, a frequency component S′(k) at a k-th band is obtained using Equation (16). Here, “S′(k)” is a frequency component after frequency change.

$$\begin{matrix}{S}^{′} ( k ) = S ( k + j ) & k = 0 , … , N - j - 1 \\ {S}^{′} ( k ) = 0 & k = N - j , … , N - 1\end{matrix} \} \qquad ( 16 )$$

Subsequently, a sound-source frequency component S′(k) obtained by Equation (16) is subjected to frequency-time conversion (Step S23). Compared with a frequency component S (k), a k value of a frequency component S′(k) after frequency conversion is small as much as equivalent to j components. Thus, a sound source signal with a frequency lowered with p (Hz). Subsequently, the processing is ended (“end” in FIG. 14).

In this way, the pitch of the sound source 10 is changed. Therefore, from the displacement or fixedness of the pitch of the sound source, the user U may easily grasp a variation Δl (t) in distance and a variation ΔΩ (t) in angle. The sound-source attribute emphasis unit 32 controls a degree of lowering a sound source pitch in response to a positional variation of the user U. When a degree of lowering the pitch is small, it becomes easy to perceive the sound source and the sound source may become clear. Since the pitch may be changed more than a change in actual distance between the user U and the destination, as compared with, for example, one that presents a sound source at a fixed pitch, the user U may be more intelligibly guided to the destination.

### Sixth Embodiment

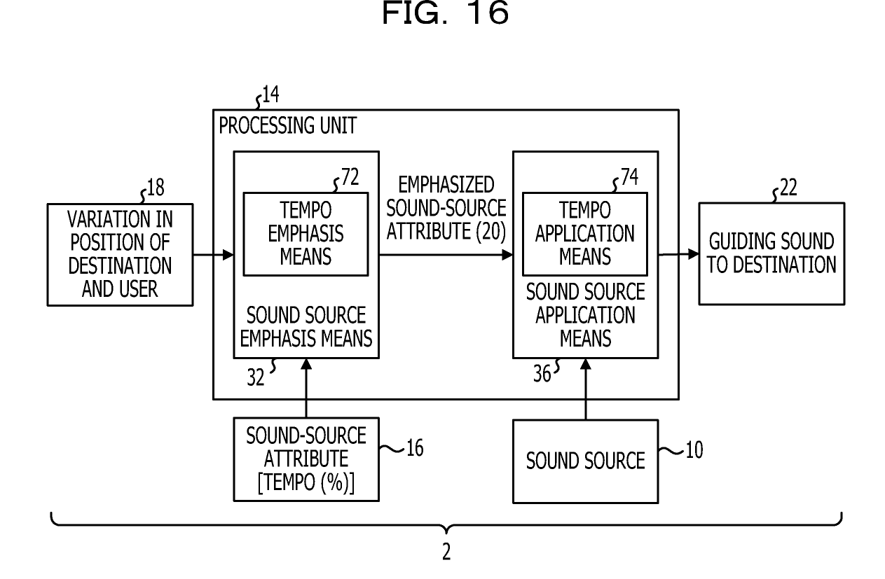

Referring to FIG. 16, a sixth embodiment will be described. FIG. 16 is a diagram illustrating an exemplary guiding sound generating apparatus according to the sixth embodiment. The configuration of the guiding sound generating apparatus illustrated in FIG. 16 is for illustrative purpose only and is not intended to limit the scope of the invention. In FIG. 16, the same reference numerals denote the same structural components as those illustrated in FIGS. 1, 4, 5, 11, 12, and 13.

According to this embodiment, a sound source with an emphasized attribute is output through a sound-source attribute emphasis unit 32 and a sound-source attribute application unit 36. The sound source then guides a user intelligibly to a destination. Since both the sound-source attribute emphasis unit 32 and the sound-source attribute application unit 36 have the same configurations as those of the second embodiment, the description thereof will be omitted hereinafter.

In a case of emphasizing the sound source 10 when a tempo (speed of sound source) is used as an exemplary sound-source attribute 16, the sound-source attribute emphasis unit 32 illustrated in FIG. 16 receives specification of “tempo” as the sound-source attribute 16. The sound-source attribute emphasis unit 32 receives a variation 18 in user's position with respect to a destination. Then, the sound-source attribute emphasis unit 32 provides a sound-source attribute of the tempo with a variation to emphasize the tempo sound-source attribution. The sound-source attribute emphasis unit 32 is provided with a tempo emphasis unit 72 as a unit for emphasizing the distance and direction between the destination and the present location.

The sound-source attribute application unit 36 illustrated in FIG. 16 has a tempo application unit 74 as a unit for generating a destination guidance sound 22 by applying a sound-source attribute, which is information about the emphasized tempo, to the sound source 10.

Next, in the emphasis using a tempo, based on a user's positional variation with respect to a destination (variation 18 in user's position with respect to the destination), for example, a destination guidance sound 22 is generated and this destination guidance sound 22 is presented to a user U. A magnification ratio m(%) of a controlled variable of a sound source tempo to be presented to the user U is defined using, for example, Equations (17), (18), and (19). A magnification ratio m(%) of a controlled variable is a rate of the tempo of the sound source to that of the original sound source 10.

$$\begin{matrix}m ( Δ 1 ( t ) , ΔΦ ( t ) ) = coeff\_m * m 1 ( Δ1 ( t ) ) + ( 1 - coeff\_m ) m 2 ( ΔΦ ( t ) ) & ( 17 ) \\ \{ \begin{matrix}m 1 ( t ) = f 1 ( t ) ( {M}_{max} - {M}_{min} ) + {M}_{min} & Δ l ( t ) < 0 \\ m 1 ( t ) = f 2 ( t ) ( {M}_{max} - {M}_{min} ) + {M}_{min} & Δ l ( t ) > 0 \\ m 1 ( t ) = 1.0 & Δ l ( t ) = 0\end{matrix} & ( 18 ) \\ \{ \begin{matrix}m 2 ( t ) = f 1 ( t ) ( {M}_{max} - {M}_{min} ) + {M}_{min} & ΔΦ ( t ) < 0 \\ m 2 ( t ) = f 2 ( t ) ( {M}_{max} - {M}_{min} ) + {M}_{min} & ΔΦ ( t ) > 0 \\ m 2 ( t ) = 1.0 & ΔΦ ( t ) = 0\end{matrix} & ( 19 )\end{matrix}$$

In the equations, “Mmax” represents the maximum value of m, for example, which is set to 2; “Mmin” represents the minimum value of m, for example, which is set to 0.5; and “coeff_m” represents contribution of m1 and is set to a value in a range of 0 to 1.

Since both f1 (t) and f2 (t) are the same as those of the second embodiment, the description thereof will be omitted hereinafter.

A value of m1 (t) represents emphasis on distance. When Equation (5) is used as f1 (t) and Δl (t) is smaller than 0 (zero), the value of m1(t) is linearly decreased from Mmax to Mmin with time. When the value is decreased to Mmin, then the value is rapidly increased to Mmax. Then, such a variation in value may be repeatedly given at cycle “a”. When Equation (6) is used as f2 (t) and Δl (t) exceeds 0 (zero), the value of m1(t) is linearly increased from Mmin to Mmax with time. When a value increases to Mmax, then the value decreases to Mmin rapidly. Then, such a variation in value may be repeatedly given at cycle “a”. When Δl (t) is 0 (zero) and variation 18 in user's position with respect to the destination is 0 (zero), m1(t) is set to 1.0. Thus, the function m1(t) is changed according to Δl (t) as a variation 18 in user's position with respect to the destination. The distance can be emphasized using a tempo.

A value of m2 (t) represents emphasis on direction. When Equation (5) is used as f1 (t) and ΔΩ (t) is smaller than 0 (zero), the value of m2 (t) is linearly decreased from Mmax to Mmin with time. When a value decreases to Mmin, a value rises to Mmax rapidly. Then, such a variation in value may be repeatedly given at cycle “a”. When Equation (6) is used as f2 (t) and Δl (t) exceeds 0 (zero), the value of m2(t) is linearly increased from Mmin to Mmax with time. When a value increases to Mmin, then the value decreases to Mmax rapidly. Then, such a variation in value may be repeatedly given at cycle “a”. When ΔΦ (t) is 0 (zero) and variation 18 in user's position with respect to the destination is 0 (zero), m2(t) is set to 1.0. Thus, the function m2(t) is changed according to ΔΦ (t) as a variation 18 in user's position with respect to the destination. The direction can be emphasized using a tempo.

In m (Δl (t), ΔΦ (t)), a value m1(t) representing emphasis on distance and a value m2(t) representing emphasis on direction are multiplied by a coefficient coeff_m and a coefficient (1−coeff_m), followed by addition of m1 (t) and m2 (t). Thus, m(Δl (t), ΔΦ (t)) allows emphasis on distance and direction. Both the distance and the direction may be emphasized when a sound source is emphasized by m(Δl (t), ΔΦ (t)). When coeff_m is set in a range of 0 to less than 0.5, m (Δl (t), ΔΦ (t)) emphasizes the direction rather than the distance. When coeff_m is set in a range of more than 0.5 to 1, m (Δl (t), ΔΦ (t)) emphasizes the distance rather than the direction. When coeff_m is set to 0.5, m (Δl (t), ΔΦ (t)) emphasizes the distance and the direction equally. When coeff_m is set to zero, m (Δl (t), ΔΦ (t)) is set to emphasize the direction. When coeff_m is set to 1 (one), m (Δl (t), ΔΦ (t)) is set to emphasize the distance rather than the direction. In this way, since Equation (17) representing m (Δl (t), ΔΦ (t)) includes coefficients coeff_m and (1−coeff_m), it is possible to set a rate of emphasizing the direction and the distance as a specified value or an arbitrarily value. Flexibility of selecting degrees of emphasizing the distance and the direction is enhanced.

Next, in processing for generating a destination guidance sound 22 from the variation in user's position with respect to the destination, for example, processing for emphasizing a sound-source attribute (Step S1 in FIG. 3) and processing for applying an emphasized sound-source attribute (Step S2 in FIG. 3) are performed.

(1) Processing for Emphasizing a Sound-Source Attribute

As a variation 18 in user's position with respect to the destination, a variation Δl (t) of distance and a variation ΔΩ (t) of angle are input in the sound-source attribute emphasis unit 32, and a “tempo” is input in the sound-source attribute emphasis unit 32 as a sound-source attribute 16. The tempo emphasis unit 72 of the sound-source attribute emphasis unit 32 changes a volume sound-source attribute by calculating m1 (t) according to a variation Δl (t) of distance to emphasize the distance. The tempo emphasis unit 72 of the sound-source attribute emphasis unit 32 calculates m2 (t) according to a variation ΔΩ (t) in angle to change a tempo attribute, thereby emphasizing the direction. Using m1 (t) and m2 (t), the tempo emphasis unit 72 calculates m (Δl (t), ΔΦ (t)), and emphasizes both distance and direction. Thus, a sound-source attribute is emphasized by the tempo emphasis unit 72.

The sound-source attribute emphasis unit 32 outputs m (Δl (t), (t)) as a sound-source attribute 20 of the emphasized tempo. Then the sound-source attribute 20 of the emphasized tempo is input in the sound-source attribute application unit 36.

(2) Processing for Application of Emphasized Sound-Source Attribute

When a sound-source attribute 20 of an emphasized tempo and a sound source 10 are input in the sound-source attribute application unit 36, the sound source is changed by a method for converting a speed using a signal wave form so that a tempo of the sound source becomes m (%). Here, “m” represents a value obtained by Equation (17), i.e., m, (Δl (t), ΔΦ (t)).

A tempo conversion may be performed using, for example, a method for converting a speed using a signal wave. As an example of the speed-conversion method, there is a time-domain harmonic scaling (TDHS) (described in Sadaaki Furui “Electronic Intelligence Communication Engineering Series Speech Information Processing”, pages 59-60, published from Morikita Publishing Co., Ltd.). In this time-domain harmonic scaling technology, a compression or expansion is performed by merging adjacent pitch components in consideration of temporal continuity after multiplying them by appropriate different weights depending on their positions on a time axis. Specifically, when the pitches are doubled by the extension, sections of overlapped 2P are respectively multiplied by weights and summed, followed by being compressed to the length of P to sample it with ½ of the original cycle.

In this way, the tempo of the sound source 10 is changed. Therefore, from the displacement or fixedness of the tempo of the sound source, the user U may easily grasp a variation Δl (t) in distance and a variation ΔΩ (t) in angle. According to the positional variation of the user U, the sound-source attribute emphasis unit 32 controls the angle of a sound-source attribute so that the sound source tempo may be increased when the user U approaches the destination direction and the sound source tempo may be lowered when the user U moves away from the destination direction. By controlling the sound source tempo, it becomes easy to perceive the sound source and the sound source becomes clear. Since the sound source tempo may be changed depending on a change in distance between the user U and the destination, or whether the user U moves away from the destination or approaches to the destination, the user U may be guided intelligibly to the destination as compared to another system that presents a fixed sound source tempo to the user U.

### Seventh Embodiment

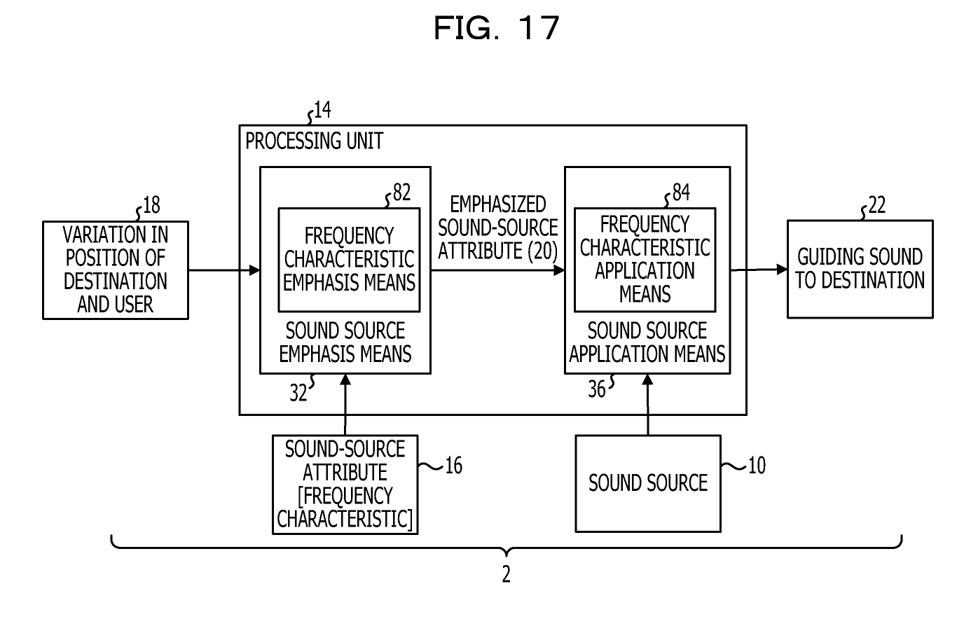

Referring to FIG. 17, a seventh embodiment will be described. FIG. 17 is a diagram illustrating an exemplary guiding sound generating apparatus according to the second embodiment. The configuration of the guiding sound generating apparatus illustrated in FIG. 17 is for illustrative purpose only and is not intended to limit the scope of the invention. Identical codes are given to an FIG. 1, FIG. 4, FIG. 5, FIG. 11, FIG. 12, an FIG. 13 and FIG. 16, and identical parts.

According to this embodiment, a sound source with an emphasized attribute is output through a sound-source attribute emphasis unit 32 and a sound-source attribute application unit 36. The sound source then guides a user intelligibly to a destination. Since both the sound-source attribute emphasis unit 32 and the sound-source attribute application unit 36 have the same configurations as those of the second embodiment, the description thereof will be omitted hereinafter.

When emphasizing a sound source 10 using a sound-source attribute 16, such as frequency characteristic information, the sound-source attribute emphasis unit 32 illustrated in FIG. 17 receives specification of a “frequency characteristic” as sound-source attribute 16. The sound-source attribute emphasis unit 32 receives a variation 18 in user's position with respect to a destination. Then, the sound-source attribute emphasis unit 32 provides a sound-source attribute of the tempo with a variation to emphasize the frequency-characteristic sound-source attribution. The sound-source attribute emphasis unit 32 is provided with a frequency-characteristic emphasis unit 82 as a unit that utilizes a frequency characteristic to emphasize the distance and direction between the destination and the present location.

The sound-source attribute application unit 36 illustrated in FIG. 12 has a sound-source application unit 84 as a unit for generating a destination guidance sound 22 by applying a sound-source attribute 20, which is information about the emphasized frequency characteristic, to the sound source 10.

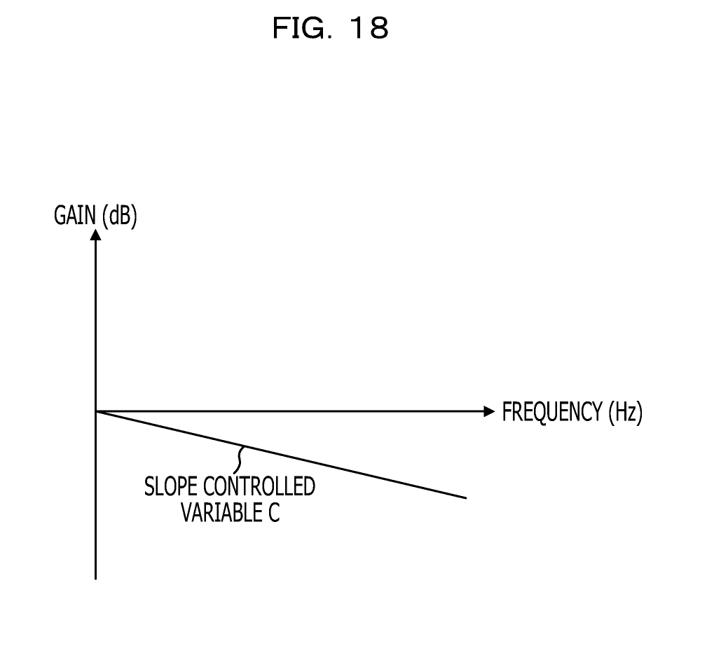

Next, in the emphasis using a frequency characteristic, for example, based on a user's positional variation with respective to a destination (variation 18 in user's position with respect to the destination), a destination guidance sound 22 is generated and this destination guidance sound 22 is presented to a user U. A controlled variable c (db/Hz) of a sound-source frequency-characteristic slope to be presented to the user is determined, for example using Equation (20), Equation (21), and Equation (22). This controlled variable c of the sound-source frequency-characteristic slope is a quantity that represents a slope of a straight line (frequency characteristic line) on a x-y coordinate system illustrated in FIG. 18, where a horizontal axis (x axis) represents frequency (Hz) and a vertical axis (y axis) represents gain (dB).

$$\begin{matrix}c ( Δ 1 ( t ) , ΔΦ ( t ) ) = coeff\_c * c 1 ( Δ1 ( t ) ) + ( 1 - coeff\_c ) c 2 ( ΔΦ ( t ) ) & ( 20 ) \\ \{ \begin{matrix}c 1 ( t ) = f 1 ( t ) ( {C}_{max} - {C}_{min} ) + {C}_{min} & Δ l ( t ) < 0 \\ c 1 ( t ) = f 2 ( t ) ( {C}_{max} - {C}_{min} ) + {C}_{min} & Δ l ( t ) > 0 \\ c 1 ( t ) = 1.0 & Δ l ( t ) = 0\end{matrix} & ( 21 ) \\ \{ \begin{matrix}c 2 ( t ) = f 1 ( t ) ( {C}_{max} - {C}_{min} ) + {C}_{min} & ΔΦ ( t ) < 0 \\ c 2 ( t ) = f 2 ( t ) ( {C}_{max} - {C}_{min} ) + {C}_{min} & ΔΦ ( t ) > 0 \\ c 2 ( t ) = 1.0 & ΔΦ ( t ) = 0\end{matrix} & ( 22 )\end{matrix}$$

In the equations, “Cmax” represents the maximum value of c, for example, which is set to 5; “Cmin” represents the minimum value of c, for example, which is set to 0; and “coeff_c” represents contribution, of c1 and is set to a value in a range of 0 to 1.

Since both f1 (t) and f2 (t) are the same as those of the second embodiment, the description thereof will be omitted hereinafter.

A value of c1 (t) represents emphasis on distance. When Equation (5) is used as f1 (t) and Δl (t) is smaller than 0 (zero), the value of c1(t) is linearly decreased from Cmax to Cmin with time. When the value is decreased to Cmin, then the value is rapidly increased to Cmax. Then, such a variation in value may be repeatedly given at cycle “a”. When Equation (6) is used as f2 (t) and Δl (t) exceeds 0 (zero), the value of c1(t) is linearly increased from Cmin to Cmax with time. When the value is increased to Cmax, then the value is rapidly decreased to Cmin. Then, such a variation in value may be repeatedly given at cycle “a”. When Δl (t) is 0 (zero) and variation 18 in user's position with respect to the destination is 0 (zero), c1(t) is set to 1.0. Thus, the function c1(t) is changed according to Δl (t) as a variation 18 in user's position with respect to the destination. The distance can be emphasized using a frequency characteristic.

A value of c2 (t) represents emphasis on direction. When Equation (5) is used as f1 (t) and ΔΦ (t) is smaller than 0 (zero), the value of c2(t) is linearly decreased from Cmax to Cmin with time. When the value is decreased to Cmin, then the value is rapidly increased to Cmax. Then, such a variation in value may be repeatedly given at cycle “a”. When Equation (6) is used as f2 (t) and ΔΩ (t) exceeds 0 (zero), the value of c2(t) is linearly increased from Cmin to Cmax with time. When the value is increased to Cmax, then the value is rapidly decreased to Cmin. Then, such a variation in value may be repeatedly given at cycle “a”. When ΔΦ (t) is 0 (zero) and variation 18 in user's position with respect to the destination is 0 (zero), c2(t) is set to 1.0. Thus, the function c2(t) is changed according to ΔΦ (t) as a variation 18 in user's position with respect to the destination. The direction can be emphasized using a frequency characteristic.

In c(Δl (t), ΔΦ (t)), a value c1(t) representing emphasis on distance and a value c2(t) representing emphasis on direction are multiplied by a coefficient coeff_c and a coefficient (1−coeff_c), followed by addition of c1 (t) and c2 (t). Thus, c (Δl (t), ΔΦ (t)) allows emphasis on distance and direction. When a sound source is emphasized by c(Δl (t), ΔΦ (t)), both the distance and the direction may be emphasized. When coeff_c is set in a range of 0 to less than 0.5, c (Δl (t), ΔΦ (t)) emphasizes the direction rather than the distance. When coeff_c is set in a range of more than 0.5 to 1, c (Δl (t), ΔΦ (t)) emphasizes the distance rather than the direction. When coeff_c is set to 0.5, c (Δl (t), ΔΦ (t)) emphasizes the distance and the direction equally. When coeff_c is set to 0 (zero), c (Δl (t), ΔΦ (t)) is set to emphasize the direction. When coeff_c is set to 1, c (Δl (t), ΔΦ (t)) is set to emphasize the distance. In this way, since Equation (20) representing c (Δl (t), ΔΦ (t)) includes coefficients coeff_c and (1−coeff_c), it is possible to set a rate of emphasizing the direction and the distance as a specified value or an arbitrarily value. Flexibility of selecting degrees of emphasizing the distance and the direction is enhanced.

Equation (23) represents the gain e(f) of each frequency using the slope controlled variable c. Here, the gain e (f) is a value represented by a ratio of a sound output to a sound input.

e(f)=10̂(f×c)/20000) (23)

A gain of a high-frequency high-pitch sound is increased when a slope controlled variable c becomes large. Thus, sharpness of sound will be given to auditory sensation. A gain of a high-frequency high-pitch sound is decreased when a slope controlled variable c becomes small. Thus, un-sharpness of sound is given to auditory sensation. In other words, in emphasis of the sound-source attribute using a controlled variable c (db/Hz), the controlled variable c may be varied between Cmax and Cmin, and the sharpness given to auditory sensation may be varied.

Next, in processing for generating a destination guidance sound 22 from the variation in user's position with respect to the destination, for example, processing for emphasizing a sound-source attribute (Step S11 in FIG. 14) and processing for applying an emphasized sound-source attribute (Step S12 in FIG. 14) are performed.

(1) Processing for Emphasizing a Sound-Source Attribute

As a variation 18 in user's position with respect to the destination, a variation Δl (t) of distance and a variation ΔΩ (t) of angle are input in the sound-source attribute emphasis unit 32, and a “frequency characteristic” is input in the sound-source attribute emphasis unit 32 as a sound-source attribute 16. The frequency characteristic emphasis unit 82 of the sound-source attribute emphasis unit 32 changes a frequency characteristic sound-source attribute by calculating c1 (t) according to a variation Δl (t) of distance to emphasize the distance. The frequency characteristic emphasis unit 82 calculates c2 (t) according to a variation ΔΩ (t) in angle to change a frequency-characteristic sound-source attribute, thereby emphasizing the direction. Using c1 (t) and c2 (t), the frequency characteristic emphasis unit 82 calculate sc (Δl (t), Δl (t)), and emphasizes both distance and direction. Thus, a sound-source attribute is emphasized by the frequency characteristic emphasis unit 82.

The sound-source attribute emphasis unit 32 outputs each frequency gain e(f) determined by using a controlled variable c of a frequency characteristic slope, (Δl (t), ΔΦ (t)), as a sound-source attribution 20 of the emphasized frequency characteristic, or the controlled variable c (Δl (t), ΔΦ (t)). Then the emphasized sound-source attribute of the frequency characteristic is input in the sound-source attribute application unit 36.

(2) Processing for Application of Emphasized Sound-Source Attribute

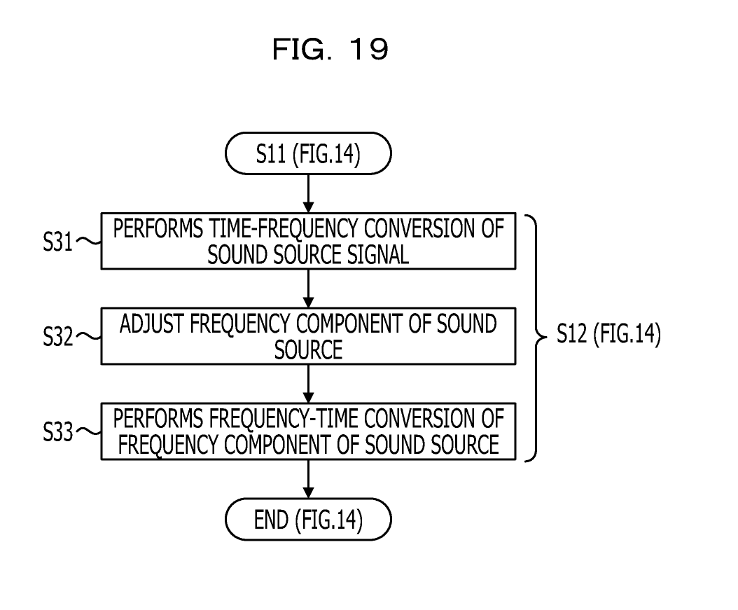

FIG. 19 is referenced for describing processing for application of emphasized sound-source attribute. FIG. 19 is a flowchart illustrating an exemplary process for application of a sound-source attribute of a frequency characteristic. The processing illustrated in FIG. 19 is for illustrative purpose only and is not intended to limit the scope of the invention. Procedures of processing for application of a frequency-characteristic sound-source attribute illustrated in FIG. 14 is a subroutine of the process for applying an emphasized sound-source attribute (Step S12) illustrated in FIG. 14.

When a sound-source attribute 20 of an emphasized frequency characteristic and a sound source 10 are input in the sound-source attribute application unit 36, the frequency characteristic application unit 84 of the sound-source attribute application unit 36 performs a time-frequency conversion of a sound source signal of the sound source 10 to obtain a frequency component S (Step S31). This time-frequency conversion divides a sound source signal into N frequency bands and then calculates a frequency component S for each frequency band. The frequency component is a complex number for every frequency (unit: Hz). The frequency component of a K-th frequency band is represented by, for example, S(k). When a sound source signal is divided into N frequency bands, for example, the division may be performed so that the widths of the respective frequency bands may be equal to one another. By dividing the frequency band in this way, management of bandwidths may be easily performed. Here, “k” is an integral in a range of 0 to N−1 and represents a divided band number.

Subsequently, a sound-source frequency component is adjusted using the gain e (f) determined using the controlled variable c (Step S32).

The frequency component S″(k) after the adjustment processing may be obtained by, for example, multiplying the frequency component S(k) before the adjustment processing by e(f).

S″(k)=S(k)*e(f) (24)

The sound-source frequency component S″(k) of the sound source after the processing obtained by Equation (24) is subjected to frequency-time conversion (Step S33). A sound source signal with an adjusted frequency characteristic is acquired and a destination guidance sound 22 is generated. After that, the processing is ended (end in FIG. 14).

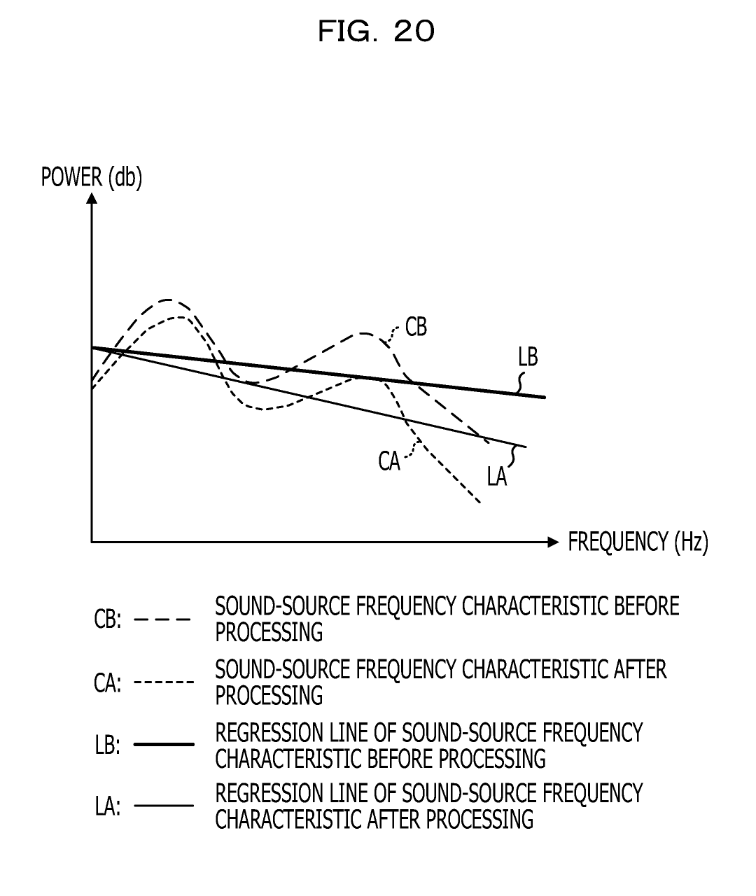

When the frequency component S(k) is adjusted using Equation (24), the frequency characteristic CB of the sound source before the processing illustrated in FIG. 20 is adjusted to a frequency characteristic CA of the sound source after the processing. That is, as compared with a regression line LB of the frequency characteristic CB of the sound source before the processing, the slope quantity of a regression line LA of the frequency characteristic CA of the sound source after processing becomes large (the value of the slope becomes small). Since a frequency characteristic CA of the sound source after the processing and a slope of a regression line LA″ are changed by emphasizing the frequency characteristic, the user U may easily grasp a variation Δl (t) in distance and a variation ΔΦ (t) in angle.

According to the positional variation of the user U, the sound-source attribute emphasis unit 32 controls the sound-source frequency-characteristic slope so that the sound-source frequency-characteristic slope may become larger when the user U approaches the destination direction and the sound-source frequency-characteristic slope may become smaller when the user U moves away from the destination direction. When the frequency-characteristic slope increases, it may become easy to perceive the sound source and the sound source may become clear. Since the sound-source frequency-characteristic slope may be changed depending on a change in distance between the user U and the destination, or whether the user U moves away from the destination or approaches to the destination, the user U may be guided more intelligibly to the destination as compared to a system that presents a fixed sound-source frequency-characteristic slope to the user U.

### Eighth Embodiment

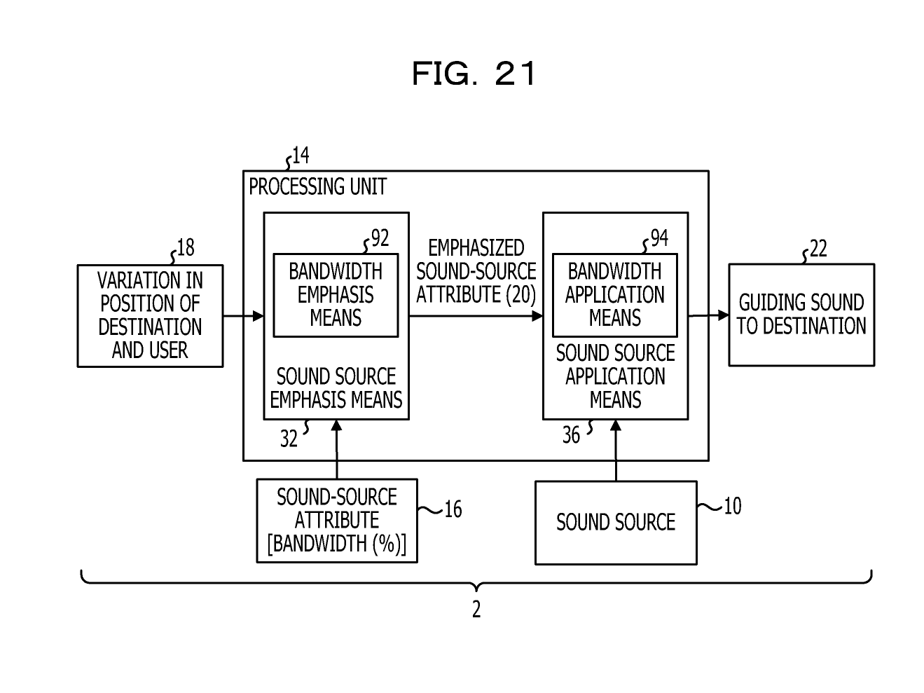

Referring to FIG. 21, an eighth embodiment will be described. FIG. 21 is a diagram illustrating an exemplary guiding sound generating apparatus according to the eighth embodiment. The configuration of the guiding sound generating apparatus illustrated in FIG. 21 is for illustrative purpose only and is not intended to limit the scope of the invention. In FIG. 21, the same reference numerals denote the same structural components as those illustrated in FIGS. 1, 4, 5, 11, 12, 13, 16, and 17.

According to this embodiment, a sound source with an emphasized attribute is output through a sound-source attribute emphasis unit 32 and a sound-source attribute application unit 36 and guides a user intelligibly to a destination. Since both the sound-source attribute emphasis unit 32 and the sound-source attribute application unit 36 have the same configurations as those of the second embodiment, the description thereof will be omitted hereinafter.

In a case of emphasizing the sound source 10 when bandwidth information is used as an exemplary sound-source attribute 16, the sound-source attribute emphasis unit 32 illustrated in FIG. 21 receives specification of “bandwidth” as the sound-source attribute 16. The sound-source attribute emphasis unit 32 receives a variation 18 in user's position with respect to a destination. Then, the sound-source attribute emphasis unit 32 provides a bandwidth sound-source attribute with a variation to emphasize the bandwidth sound-source attribution. In response to the received information, a distance and a direction between the destination and the present location are emphasized and output. The sound-source attribute emphasis unit 32 is provided with a bandwidth emphasis unit 92 as a unit that utilizes a bandwidth to emphasize the distance and direction between the destination and the present location.

The sound-source attribute application unit 36 illustrated in FIG. 21 has a bandwidth application unit 94 as a unit for generating a destination guidance sound 22 by applying information about the emphasized bandwidth to the sound source 10.

Next, in the emphasis using a sound source bandwidth, based on a user's positional variation with respect to a destination (variation 18 in user's position with respect to the destination), for example, a destination guidance sound 22 is generated and this destination guidance sound 22 is presented to a user U. A controlled variable w of a sound source bandwidth presented to the user U is determined, for example using Equation (25), Equation (26), and Equation (27). Here, the controlled variable w is a rate which makes bandwidth of the original sound source 10 small. For example, when w is 100(%), there is no reduction in bandwidth of sound source 10. In contrast, when w is 50(%), the controlled variable w represents that the bandwidth of the sound source 10 is halved.

$$\begin{matrix}w ( Δ 1 ( t ) , ΔΦ ( t ) ) = coeff\_w * w 1 ( Δ1 ( t ) ) + ( 1 - coeff\_w ) w 2 ( ΔΦ ( t ) ) & ( 25 ) \\ \{ \begin{matrix}w 1 ( t ) = f 1 ( t ) ( {W}_{max} - {W}_{min} ) + {W}_{min} & Δ l ( t ) < 0 \\ w 1 ( t ) = f 2 ( t ) ( {W}_{max} - {W}_{min} ) + {W}_{min} & Δ l ( t ) > 0 \\ w 1 ( t ) = 100.0 & Δ l ( t ) = 0\end{matrix} & ( 26 ) \\ \{ \begin{matrix}w 2 ( t ) = f 1 ( t ) ( {W}_{max} - {W}_{min} ) + {W}_{min} & ΔΦ ( t ) < 0 \\ w 2 ( t ) = f 2 ( t ) ( {W}_{max} - {W}_{min} ) + {W}_{min} & ΔΦ ( t ) > 0 \\ w 2 ( t ) = 100.0 & ΔΦ ( t ) = 0\end{matrix} & ( 27 )\end{matrix}$$

In the equations, “Wmax” represents the maximum value of w, for example, which is set to 200; “Wmin” represents the minimum value of w, for example, which is set to 0; and “coeff_w” represents contribution of w1 and is set to a value in a range of 0 to 1.

Since both f1 (t) and f2 (t) are the same as those of the second embodiment, the description thereof will be omitted hereinafter.

Here, w1 (t) expresses emphasis of distance. When Equation (5) is used as f1 (t) and Δl (t) is smaller than 0 (zero), the value of w1 (t) is linearly decreased from Wmax to Wmin with time. When the value is decreased to Wmin, then the value is rapidly increased to Wmax. Then, such a variation in value may be repeatedly given at cycle “a”. When Equation (6) is used as Q (t) and Δl (t) exceeds 0 (zero), the value of w1 (t) is linearly increased from Wmin to Wmax with time. When the value is increased to Wmax, then the value is rapidly decreased to Wmin. Then, such a variation in value may be repeatedly given at cycle “a”. When Δl (t) is 0 (zero) and variation 18 in user's position with respect to the destination is 0 (zero), w1(t) is set to 1.0. Thus, the function w1(t) is changed according to Δl (t) as a variation 18 in user's position with respect to the destination. The distance can be emphasized using a sound source bandwidth.

A value of w2 (t) represents emphasis on direction. When Equation (5) is used as f1 (t) and ΔΩ (t) is smaller than 0 (zero), the value of w2 (t) is linearly decreased from Wmax to Wmin with time. When the value is decreased to Wmin, then the value is rapidly increased to Wmax. Then, such a variation in value may be repeatedly given at cycle “a”. When Equation (6) is used as Q (t) and ΔΩ (t) exceeds 0 (zero), the value of w2 (t) is linearly increased from Wmin to Wmax with time. When the value is increased to Wmax, then the value is rapidly decreased to Wmin. Then, such a variation in value may be repeatedly given at cycle “a”. When ΔΩ (t) is 0 (zero) and variation 18 in user's position with respect to the destination is 0 (zero), w2 (t) is set to 1.0. Thus, the function w2 (t) is changed according to ΔΩ (t) as a variation 18 in user's position with respect to the destination. The direction can be emphasized using a sound source bandwidth.

In w(Δl (t), ΔΦ (t)), a value w1(t) representing emphasis on distance and a value w2 (t) representing emphasis on direction are multiplied by a coefficient coeff_w and a coefficient (1−coeff_w), followed by addition of w1 (t) and w2 (t). Thus, w(Δl (t), ΔΦ (t)) allows emphasis on distance and direction. When a sound source is emphasized by w(Δl (t), Δl (t)), both the distance and the direction may be emphasized. When coeff_w is set in a range of 0 to less than 0.5, w (Δl (t), ΔΦ (t)) emphasizes the direction rather than the distance. When coeff_w is set in a range of more than 0.5 to 1, w (Δl (t), ΔΦ (t)) emphasizes the distance rather than the direction. When coeff_w is set to 0.5, w (Δl (t), ΔΦ (t)) emphasizes the distance and the direction equally. When coeff_w is set to 0 (zero), w (Δl (t), ΔΦ (t)) is set to emphasize the direction. When coeff_w is set to 1, w (Δl (t), ΔΦ (t)) is set to emphasize the distance. In this way, since Equation (25) representing w (Δl (t), ΔΦ (t)) includes coefficients coeff_w and (1−coeff_w), it is possible to set a rate of emphasizing the direction and the distance as a specified value or an arbitrarily value. Flexibility of selecting degrees of emphasizing the distance and the direction is enhanced.

Next, in a process for generating a destination guidance sound 22 from the variation in user's position with respect to the destination, for example, a process for emphasizing a sound-source attribute (Step S11 in FIG. 14) and a process for applying an emphasized sound-source attribute (Step S12 in FIG. 14) are performed.

(1) Processing for Emphasizing a Sound-Source Attribute

As a variation 18 in user's position with respect to the destination, a variation Δl (t) of distance and a variation ΔΩ (t) of angle are input in the sound-source attribute emphasis unit 32, and a “bandwidth” is input in the sound-source attribute emphasis unit 32 as a sound-source attribute 16. The bandwidth emphasis unit 92 of the sound-source attribute emphasis unit 32 changes a volume sound-source attribute by calculating w1 (t) according to a variation Δl (t) of distance to emphasize the distance. The bandwidth emphasis unit 92 calculates w2 (t) according to a variation ΔΩ (t) in angle to change a sound-source attribute of a bandwidth, thereby emphasizing the direction. Using w1 (t) and w2 (t), the bandwidth emphasis unit 92 calculates w (Δl (t), ΔΦ (t)), and emphasizes both distance and direction. Thus, a sound-source attribute is emphasized by the bandwidth emphasis unit 92.

The sound-source attribute emphasis unit 32 outputs w (Δl (t), (t)) as a sound-source attribute 20 of the emphasized bandwidth. The sound-source attribute 20 of the emphasized bandwidth is input in the sound-source attribute application unit 36.

(2) Processing for Application of Emphasized Sound-Source Attribute

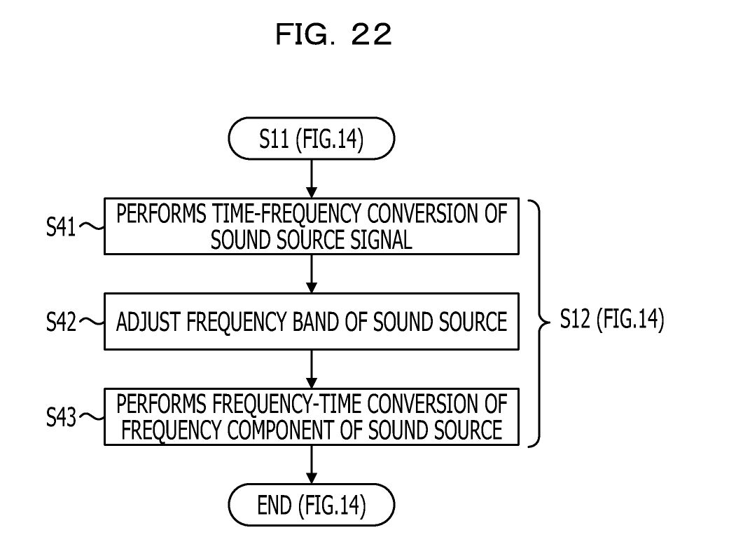

FIG. 22 is referenced for describing processing for application of emphasized sound-source attribute. FIG. 22 is a flowchart illustrating an exemplary process for application of a sound-source attribute of a bandwidth. The processing illustrated in FIG. 22 is for illustrative purpose only and is not intended to limit the scope of the invention. Procedures of the process for applying a bandwidth sound-source attribute illustrated in FIG. 22 is a subroutine of the process for applying an emphasized sound-source attribute (Step S12) illustrated in FIG. 14.

When a sound-source attribute 20 of an emphasized bandwidth and a sound source 10 are input in the sound-source attribute application unit 36, the bandwidth application unit 94 of the sound-source attribute application unit 36 performs a time-frequency conversion of a sound source signal of the sound source 10 to obtain a frequency component S (Step S41). This time-frequency conversion divides a sound source signal into N frequency bands and then calculates a frequency component S for each frequency band. The frequency component is a complex number for every frequency (unit: Hz). The frequency component of a K-th frequency band is represented by, for example, S(k). When a sound source signal is divided into N frequency bands, for example, the division may be performed so that the widths of the respective frequency bands may be equal to one another. By dividing the frequency band in this way, management of bandwidths may be easily performed. Here, “k” is an integer in a range of 0 to N−1 and represents a divided band number.

Next, a sound-source frequency band is adjusted using a bandwidth controlled variable w (Δ (t), ΔΦ (t)) (=w). (Step S42) A frequency component S′″(k) after the adjustment is set by Equation (29) using a frequency band number q calculated by Equation (28) using w. In other words, when a value of k is in a range of 0 to q−1, S′″(k) is set to the same value as that of S(k). When the value k exceeds q−1, S′″(k) is set to 0 (zero). The frequency band number q is an integer not more than a frequency band division number N.

$$\begin{matrix}q = round ( N * w / 100 ) & ( 28 ) \\ \begin{matrix}{S}^{′′′} ( k ) = S ( k ) & k = 0 , … , q - 1 \\ {S}^{′′′} ( k ) = 0 & k = q , … , N - 1\end{matrix} \} & ( 29 )\end{matrix}$$

The sound-source frequency component S′″(k) of the sound source after the processing obtained by Equation (29) is subjected to frequency-time conversion (Step S43). A sound source signal with an adjusted sound-source bandwidth is acquired and a destination guidance sound 22 is generated. After that, the processing is ended (end in FIG. 14).

When the frequency component S(k) is adjusted by Equation (29), the bandwidth is decreased to q of N. By emphasizing a bandwidth controlled variable w, a frequency band number q is changed and the bandwidth of the sound source 10 is changed. Therefore, from the displacement or fixedness of the bandwidth of the sound source 10, the user U may easily grasp a variation Δl (t) in distance and a variation ΔΦ (t) in angle. According to the positional variation of the user U, the sound-source attribute emphasis unit 32 controls the sound-source bandwidth so that the sound-source bandwidth may become larger when the user U approaches the destination direction and the sound-source bandwidth may become smaller when the user U moves away from the destination direction. When the bandwidth of the sound source increases, it may become easy to perceive the sound source and the sound source may become clear. Since the sound-source bandwidth may be changed depending on a change in distance between the user U and the destination, or whether the user U moves away from the destination or approaches to the destination, the user U may be guided more intelligibly to the destination as compared with another system that presents a fixed sound-source bandwidth to the user U.

### Ninth Embodiment

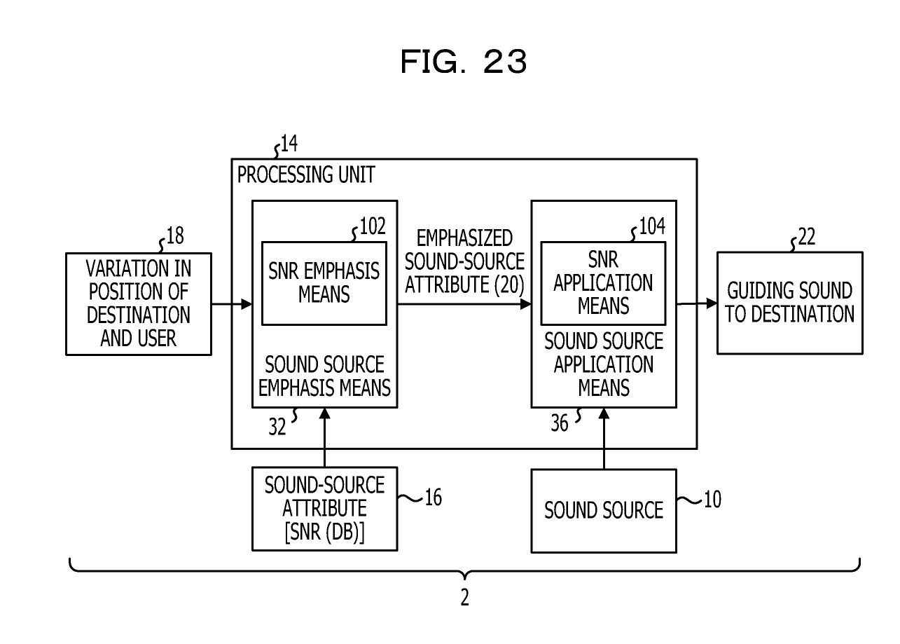

FIG. 23 is referred to for a ninth embodiment. FIG. 23 is a diagram illustrating an exemplary guiding sound generating apparatus according to the ninth embodiment. The configuration of the guiding sound generating apparatus illustrated in FIG. 23 is for illustrative purpose only and is not intended to limit the scope of the invention. In FIG. 23, the same reference numerals denote the same structural components as those illustrated in FIGS. 1, 4, 5, 11, 12, 13. 16, 17, and 21.

According to this embodiment, a guiding sound 22, which is a sound source with an emphasized attribute, is output through a sound-source attribute emphasis unit 32 and a sound-source attribute application unit 36 and guides a user intelligibly to a destination. Since both the sound-source attribute emphasis unit 32 and the sound-source attribute application unit 36 have the same configurations as those of the second embodiment, the description thereof will be omitted hereinafter.

In a case of emphasizing the sound source 10 when SNR (Signal-Noise ratio) information is used as an exemplary sound-source attribute 16, the sound-source attribute emphasis unit 32 illustrated in FIG. 23 receives specification of “SNR” as the sound-source attribute 16. The sound-source attribute emphasis unit 32 receives a variation 18 in user's position with respect to a destination. Then, the sound-source attribute emphasis unit 32 provides a sound-source attribute of the SNR with a variation to emphasize the tempo sound-source attribution. The sound-source attribute emphasis unit 32 is provided with a SNR emphasis unit 102 as a unit for emphasizing the distance and direction between the destination and the present location.

The sound-source attribute application unit 36 illustrated in FIG. 23 has a SNR application unit 104 as a unit for generating a destination guidance sound 22 by applying a sound-source attribute 20, which is information about the emphasized SNR, to the sound source 10.

Next, in the emphasis using SNR, based on a user's positional variation with respect to a destination variation 18 in user's position with respect to the destination, for example, a destination guidance sound 22 is generated and this destination guidance sound 22 is presented to a user U. A controlled variable s of a sound source SNR presented to the user U is determined, for example using Equation (30), Equation (31), and Equation (32). Here, the controlled variable s represents the size of SNR.

$$\begin{matrix}s ( Δ 1 ( t ) , ΔΦ ( t ) ) = coeff\_s * s 1 ( Δ1 ( t ) ) + ( 1 - coeff\_s ) s 2 ( ΔΦ ( t ) ) & ( 30 ) \\ \{ \begin{matrix}s 1 ( t ) = f 1 ( t ) ( {S}_{max} - {S}_{min} ) + {S}_{min} & Δ l ( t ) < 0 \\ s 1 ( t ) = f 2 ( t ) ( {S}_{max} - {S}_{min} ) + {S}_{min} & Δ l ( t ) > 0 \\ s 1 ( t ) = 1.0 & Δ l ( t ) = 0\end{matrix} & ( 31 ) \\ \{ \begin{matrix}s 2 ( t ) = f 1 ( t ) ( {S}_{max} - {S}_{min} ) + {S}_{min} & ΔΦ ( t ) < 0 \\ s 2 ( t ) = f 2 ( t ) ( {S}_{max} - {S}_{min} ) + {S}_{min} & ΔΦ ( t ) > 0 \\ s 2 ( t ) = 1.0 & ΔΦ ( t ) = 0\end{matrix} & ( 32 )\end{matrix}$$

In the equations, “Smax” represents the maximum value of s, for example, which is set to 0; “Smin” represents the minimum value of s, for example, which is set to 20; and “coeff_s” represents contribution of s1 and is set to a value in a range of 0 to 1.

Since both f1 (t) and f2 (t) are the same as those of the second embodiment, the description thereof will be omitted hereinafter.

A value of s1 (t) represents emphasis on distance. When Equation (5) is used as f1 (t) and Δl (t) is smaller than 0 (zero), the value of s1(t) is linearly decreased from Smax to Smin with time. When the value is decreased to Smin, then the value is rapidly increased to Smax. Then, such a variation in value may be repeatedly given at cycle “a”. When Equation (6) is used as f2 (t) and Δl (t) exceeds 0 (zero), the value of s1(t) is linearly increased from Smin to Smax with time. When the value is increased to Smax, then the value is rapidly decreased to Smin. Then, such a variation in value may be repeatedly given at cycle “a”. When Δl (t) is 0 (zero) and variation 18 in user's position with respect to the destination is 0 (zero), s1(t) is set to 1.0. Thus, the function s1(t) is changed according to Δl (t) as a variation 18 in user's position with respect to the destination. The distance can be emphasized using a sound source SNR.

A value of s2 (t) represents emphasis on direction. When Equation (5) is used as f1 (t) and ΔΩ (t) is smaller than 0 (zero), the value of s2 (t) is linearly decreased from Smax to Smin with time. When the value is decreased to Smin, then the value is rapidly increased to Smax. Then, such a variation in value may be repeatedly given at cycle “a”. When Equation (6) is used as f2 (t) and ΔΦ (t) exceeds 0 (zero), the value of s2 (t) is linearly increased from Smin to Smax with time. When the value is increased to Smax, then the value is rapidly decreased to Smin. Then, such a variation in value may be repeatedly given at cycle “a”. When ΔΩ (t) is 0 (zero) and variation 18 in user's position with respect to the destination is 0 (zero), s2 (t) is set to 1.0. Thus, the function s2 (t) is changed according to ΔΩ (t) as a variation 18 in user's position with respect to the destination. The direction can be emphasized using a sound source SNR.

In s(Δl (t), ΔΦ (t)), a value s1(t) representing emphasis on distance and a value s2 (t) representing emphasis on direction are multiplied by a coefficient coeff_s and a coefficient (1−coeff_s), followed by addition of s1 (t) and s2 (t). Thus, s (Δl (t), ΔΦ (t)) allows emphasis on distance and direction. When a sound source is emphasized by s (Δl (t), ΔΦ (t)), both the distance and the direction may be emphasized. When coeff_s is set in a range of 0 to less than 0.5, s (Δl (t), ΔΦ (t)) emphasizes the direction rather than the distance. When coeff_s is set in a range of more than 0.5 to 1, s (Δl (t), ΔΦ (t)) emphasizes the distance rather than the direction. When coeff_s is set to 0.5, s (Δl (t), ΔΦ (t)) emphasizes the distance and the direction equally. When coeff_s is set to 0 (zero), s (Δl (t), M (t)) is set to emphasize the direction. When coeff_s is set to 1, s (Δl (t), ΔΦ (t)) is set to emphasize the distance. In this way, since Equation (30) representing s (Δl (t), ΔΦ (t)) includes coefficients coeff_s and (1−coeff_s), it is possible to set a rate of emphasizing the direction and the distance as a specified value or an arbitrarily value. Flexibility of selecting degrees of emphasizing the distance and the direction is enhanced.

Next, during a process for generating a destination guidance sound 22 from the variation in user's position with respect to the destination, for example, a process for emphasizing a sound-source attribute (Step S11 in FIG. 14) and a process for applying an emphasized sound-source attribute (Step S12 in FIG. 14) are performed.

(1) Processing for Emphasizing a Sound-Source Attribute

As a variation 18 in user's position with respect to the destination, a variation Δl (t) of distance and a variation ΔΦ (t) of angle are input in the sound-source attribute emphasis unit 32, and a “SNR” is input in the sound-source attribute emphasis unit 32 as a sound-source attribute 16. The SNR emphasis unit 102 of the sound-source attribute emphasis unit 32 changes a SNR sound-source attribute by calculating s1 (t) according to a variation Δl (t) of distance to emphasize the distance. The SNR emphasis unit 102 calculates s2 (t) according to a variation ΔΩ (t) of the angle to change the SNR sound-source attribute, thereby emphasizing the direction. The SNR emphasis unit 102 calculates s (Δl (t), ΔΦ (t))) using s1(t) and s2 (t) to obtain s(Δl (t), ΔΦ (t)), thereby emphasizing the distance and the direction. Thus, a sound-source attribute is emphasized by the SNR emphasis unit 102.

The sound-source attribute emphasis unit 32 outputs s (Δl (t), ΔΦ (t)) as a sound-source attribute 20 of the emphasized SNR. Then the emphasized sound-source attribute 20 of the SNR is input in the sound-source attribute application unit 36.

(2) Processing for Application of Emphasized Sound-Source Attribute

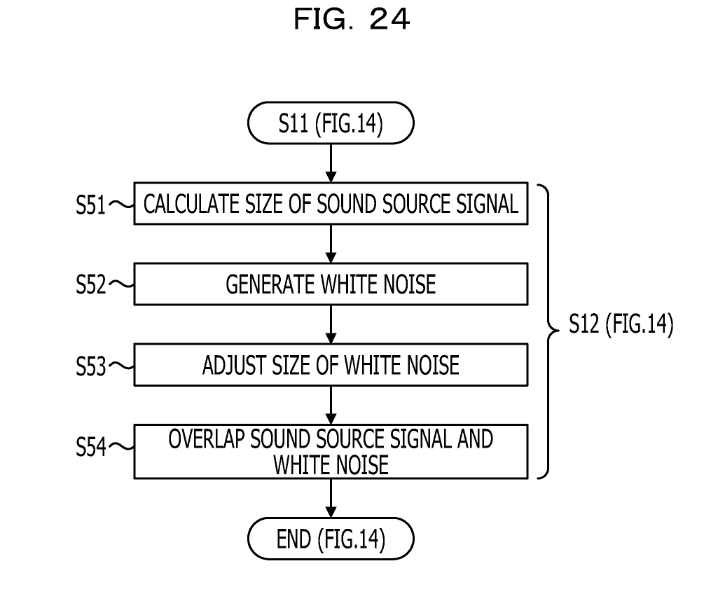

FIG. 24 is referenced for describing a process for application of an emphasized sound-source attribute. FIG. 24 is a flow chart illustrating an exemplary process for application of a sound-source attribute of SNR. The processing illustrated in FIG. 24 is for illustrative purpose only and is not intended to limit the scope of the invention. The procedures of the process for applying a SNR sound-source attribute illustrated in FIG. 24 are a subroutine of the process for applying an emphasized sound-source attribute (Step S12) illustrated in FIG. 14.

When a sound-source attribute 20 of an emphasized SNR and a sound source 10 are input in the sound-source attribute application unit 36, a size S1 of a sound source signal (dB) of the sound source 10 is measured and calculated (Step S51). The size S1 of the sound source signal (dB) is represented by Expression (33).

$$S I = 10 * log 10 ( \frac{1}{Q} {\sum }_{0}^{Q - 1} {sig ( t )}^{2} ) \qquad ( 33 )$$

In the equation, “S1” represents the Size of a sound source signal (dB); and “Q” represents a number of frame samples.

Next, a white noise is generated (Step S52). The white noise is a noise that includes all the frequency components in equal proportions and may be obtained by a method for generating it as a random number having a normal distribution. Things can be carried out that it may be the method of generating as a random number with a normal distribution. After acquiring the white noise, the white noise is adjusted so that the size of white noise may be set to a controlled variable s (dB) of SNR (Step S53). Here, the controlled variable s (dB) of SNR is an input s (Δl (t), ΔΦ (t)) value in the sound-source attribute application unit 36. Adjustment of the white noise is performed by, for example, Equation (34).

$${w}^{′} ( t ) = {10}^{( \frac{S I - s}{20} )} w ( t ) \qquad ( 34 )$$

In the formula “w (t)” represents a sample w′ (t) of a white noise signal before the adjustment: a sample of a white noise signal after the adjustment.

And the sound source signal and white noise of sound source 10 are superposed (Step S54), destination guidance sound 22 is generated, and processing is ended. (end of FIG. 14) Superposition of this sound source signal and white noise is performed, for example according to the formula (35).

sig′(t)=sig(t)+w′(t) (35)

When the amount of noise to be superposed on the sound source 10 is adjusted as a SNR, the user U may easily grasp a variation Δl (t) in distance and a variation ΔΩ (t) in angle from a change in noise. According to the positional variation of the user U, the sound-source attribute emphasis unit 32 controls the sound-source SNR so that the sound-source SNR may become large when the user U approaches the destination direction and the sound-source SNR may become small when the user U moves away from the destination direction. When the SNR of the sound source becomes large, it may become easy to perceive the sound source and the sound source may become clear. Since the sound-source SNR may be changed depending on a change in distance between the user U and the destination, or whether the user U moves away from the destination or approaches to the destination, the user U may be guided more intelligibly to the destination as compared to another system which presents a fixed sound-source SNR to the user U.

### Tenth Embodiment

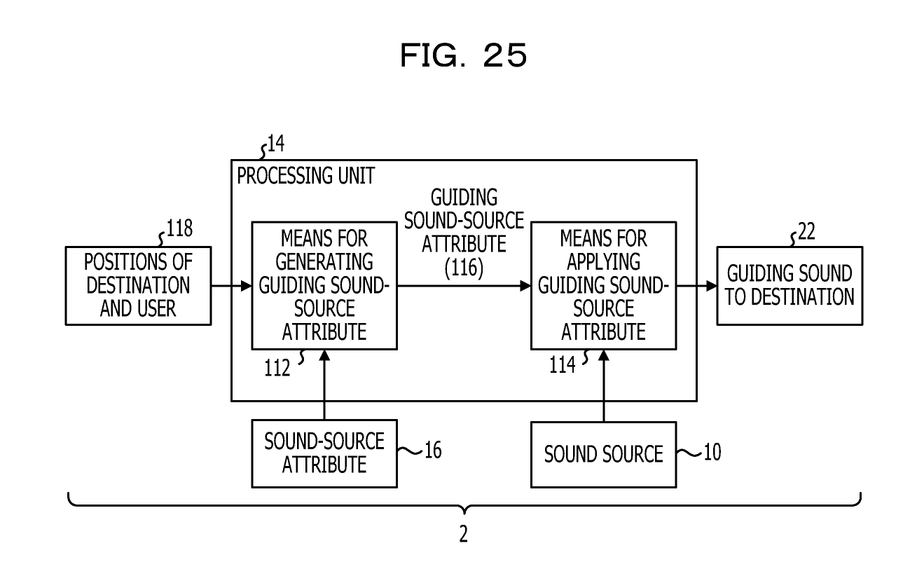

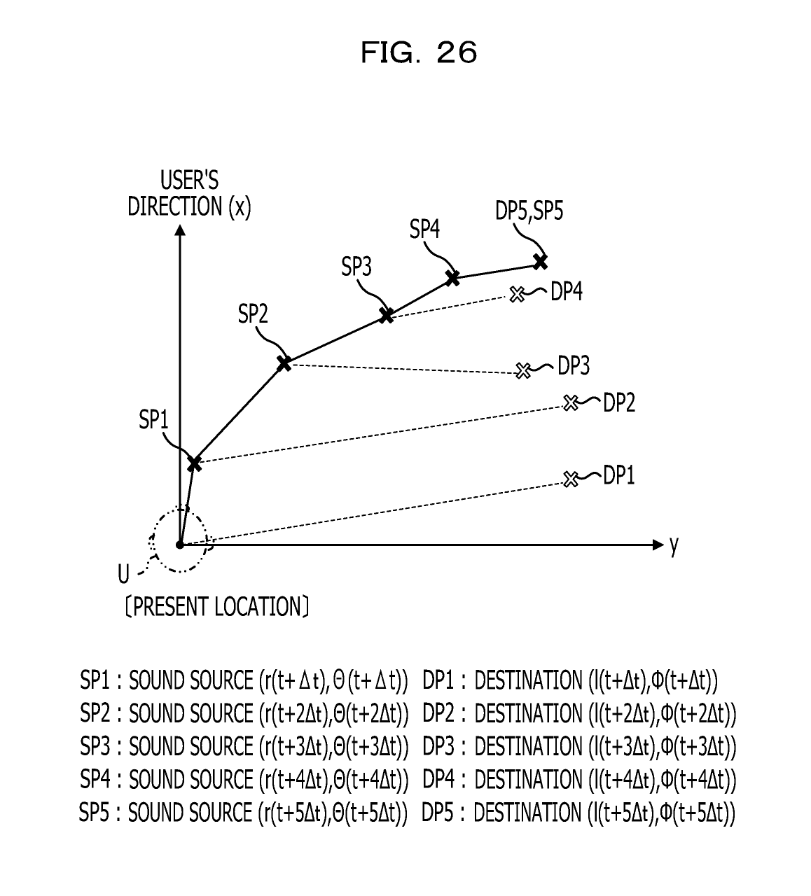

Referring to FIG. 26, a tenth embodiment will be described. FIG. 25 is a diagram illustrating an exemplary guiding sound generating apparatus according to the tenth embodiment. The configuration of the guiding sound generating apparatus illustrated in FIG. 25 is for illustrative purpose only and is not intended to limit the scope of the invention. In FIG. 25, the same reference numerals denote the same structural components as those illustrated in FIGS. 1, 5, 11, 12, 13. 16, 17, 21, and 23.

A guiding sound-source attribute generation unit 112 is an example of attribute emphasis unit 4 or a variable sound-source attribute unit. As a sound-source attribute 16, the guiding sound-source attribute generation unit 112 receives specification of a “distance” and a “direction” as sound-source attribute 16, and receives distance l(t) and angle Φ (t) as information about a destination and a user's position 118. In other words, the distance l(t) and the angle Φ (t) are information that represents the position of the user with respect to the destination. According to the received information about the distance l(t) and the angle Φ (t), the guiding sound-source attribute generation unit 112 changes and emphasizes both information about a distance between the destination and the present location and information about a direction between the destination and the present location. The guiding sound-source attribute generation unit 112 generates a guiding sound-source attribute 116 where the information about the distance and the information about the direction are emphasized. This emphasized guiding sound-source attribute 116 is an example of the emphasized sound-source attribute 20, and includes, for example, a guiding sound-source attribute. The guiding sound-source attribute 116 is a guiding sound-source attribute obtained by emphasizing information about the direction and the information about the direction so that the user U tends to recognize the direction of the destination intuitively. Here, the information about the distance between the destination and the present location and the information about the direction between the destination and the present location is an exemplary sound-source attribute 16. Since the information l(t) and Φ (t) about positional relationship between the destination and the user is the same as that of the second embodiment, the description thereof will be omitted hereinafter.

A guiding sound-source attribute application unit 114 is an example of the attribute application unit 6. The guiding sound-source attribute application unit 114 changes the sound-source attribute of the input sound source 10 into an emphasized sound-source attribute by using the guiding sound-source attribute 116 generated from the guiding sound-source attribute generation unit 112. Then, the guiding sound-source attribute application unit 114 calculates and generates a destination guidance sound 22 from the sound source 10 acquired by change of the sound-source attribute. The destination guidance sound 22 is a guiding sound for guiding a user so that it may allow a user to easily recognize the direction of a destination by change of the sound-source attribute.

Next, with reference to FIG. 26, the emphasis on distance and direction will be described. An x-y coordinate plane illustrated in FIG. 26 is one where a user U is placed on the origin thereof. A front direction of the user U is set to a positive direction of an x-axis and a right direction of the user U is set to a positive direction of a y axis. The position of the destination and the position of the sound source illustrated in FIG. 26 are only provided for schematically recognizing emphasis of distance and direction, so that the present invention is not limited to any positional relationship illustrated in the figure. In FIG. 26, furthermore, adjacent sound sources are provided with a linear line for descriptive purposes in order to easily recognize a move destination of the position of the sound source.

A relative position of a destination to the user U changes, for example, when the user U moves with time, the destination moves with time, or both the user U and the destination move with time. DP1, DP2, DP3, DP4, and DP5, which are illustrated in FIG. 26, represent the relative positions of the destination with respective to the user, which moves with time. DP1 is a destination position at a time of (t+Δt), DP2 is a destination position at a time of (t+2Δt), DP3 is a destination position at a time of (t+3Δt), DP4 is a destination position at a time of (t+4Δt), and DP5 is a destination position at a time of (t+5Δt). A sound source SP on a stereophonic sound moves every minute time Δt according to a destination position at each time to emphasize the destination position at each time. The positions of the sound source SP illustrates in FIG. 26 are set to SP1 at time (t+Δt), SP2 at time (t+2Δt), SP3 at time (t+3Δt), SP4 at time (t+4Δt), and SP5 at time (t+5Δt), respectively. Here, the amount of time is a time enough to allow the user to recognize positional changes of a sound source as a sequence of changes, for example, a time of several-millisecond to several-second order. The sound source SP on the stereophonic sound provides the user with a stereophonic sound, and is obtained when the user U acquires a sound-source localization. Provision of a stereophonic sound to a user is the same as one of the second embodiment and thus the description thereof will be omitted.

A destination position at each time may be represented using, for example distance I and angle Φ. Also, a sound source position at each time is represented using, for example, distance r and angle θ. Furthermore, the distance represented by each of distance I and distance r and the angle represented by each of angle Φ and the angle θ are the same as those of the second embodiment, and thus the description thereof will be omitted.

Position of destination DP1: (distance, angle)=(l (t+Δt), Φ (t+Δt))

Position of destination DP2: (distance, angle)=(l (t+2Δt), Φ (t+2Δt))

Position of destination DP3: (distance, angle)=(l (t+3Δt), Φ (t+3Δt))

Position of destination DP4: (distance, angle)=(l (t+4Δt), Φ (t+4Δt))

Position of destination DP5: (distance, angle)=(l (t+5Δt), Φ (t+5Δt))

Sound source position SP1: (distance, angle)=(r (t+Δt), θ (t+Δt))

Position of optical source SP2: (distance, angle)=(r (t+2Δt), θ (t+2Δt))

Sound source position SP3: (distance, angle)=(r (t+3Δt), θ (t+3Δt))

Sound source position SP4: (distance, angle)=(r (t+4Δt), θ (t+4Δt))

Sound source position SP5: (distance, angle)=(r (t+5Δt), θ (t+5Δt))

A position of a sound source (i.e., sound source position) SP is set so that it may reach a destination after moving through a plurality of different sound source positions by displacement at every minute time Δt. For example, FIG. 26 illustrates five different positions SP1 to SP5 of a sound source and the movement of the sound source from one position to another is performed such that the sound source position is displaced four times to reach a destination DP5. In this case, a first sound source position is set to a small distance and a small angle with respect to a destination position, and, as the sound source shifts its position one by one, or repeats presentation of a sound source position, it is set to shorten and reduce the distance and the angle with respect to the destination position. Furthermore, it is set so that the destination position and the sound source position are overlapped after performing a plurality of movements among sound source positions. In the movement of a sound source through different positions illustrated in FIG. 26, the sound source travels from the sound source position SP1 to the sound source position SP5. In this case, the sound source position SP5 is overlapped with the destination position DP 5. Destination DP is emphasized by setting up like previous statement of sound source SP. This sound source SP's setup is performed by guiding sound-source attribute generation unit 112.

A sound source position SP illustrated in FIG. 26 is changed, for example with respect to distance, from a position near a user U, such as one close to user's ears, to a position at a distance close to a destination. Furthermore, a sound source position SP illustrated in FIG. 26 is changed, for example with respect to direction, so as to approach from a position, to which a user U faces, to a position. The sound source position SP is changed and moves from the user position to the destination position. These changes of the sound source position SP allow the destination to be emphasized.

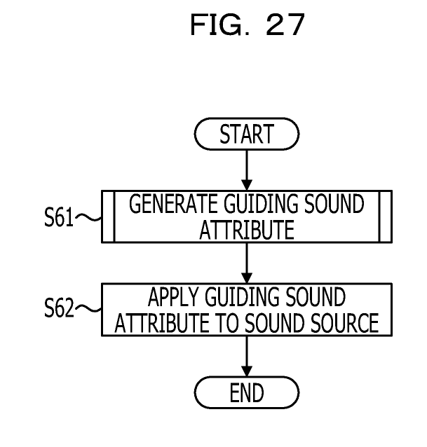

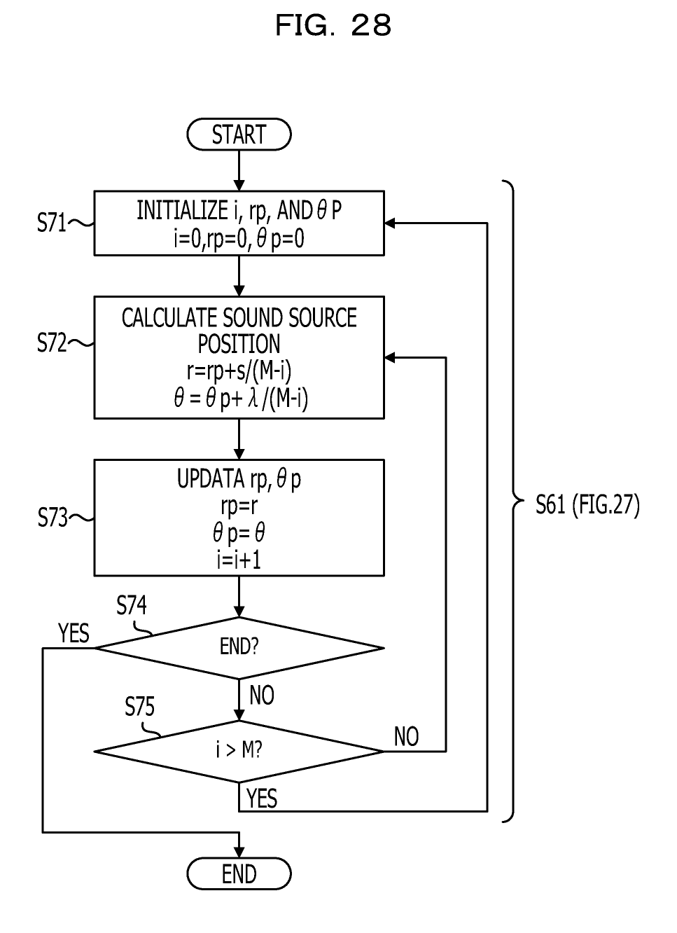

Next, processing for generating a destination guidance sound from variation in user position with respect to the destination with reference to FIG. 27 and FIG. 28. FIG. 27 is a flow chart illustrating an exemplary process for generating a guiding sound. FIG. 28 is a flow chart illustrating an exemplary process for generating a guiding sound-source attribute. The processing illustrated in FIG. 27 and FIG. 28 is for illustrative purpose only and is not intended to limit the scope of the invention. FIG. 28 illustrates a subroutine of processing for generating a guiding sound-source attribute (Step S61) illustrated in FIG. 27.

The procedure illustrated in FIG. 27 is performed by the guiding sound-source attribute generation unit 112 and the guiding sound-source attribute application unit 114, which are installed in the processing unit 14.

When the guiding sound-source attribute generation unit 112 receives information about a user's position 118 and specification of a distance and an angle as a destination. The guiding sound-source attribute generation unit 112 generates a guiding sound-source attribute 116 (Step S61) to allow, for example, a user to easily recognize the direction of a destination intuitively. This generated guiding sound-source attribute 116 is output toward the guiding sound-source attribute application unit 114.

The guiding sound-source attribute application unit 114 applies a guiding sound-source attribute 116, which is generated by the guiding sound-source attribute generation unit 112, to a sound source 10 (Step S62) to convert an attribute of the sound source 10 into an emphasized attribute. The sound to which the guiding sound-source attribute 116 is applied is output as a destination guidance sound 22. Destination guidance sound 22 changes a sound-source attribute of a direction and a sound-source attribute of a distance so that the user may easily recognize the direction of a destination and may be easily guided thereto.

Next, the generation of a guiding sound-source attribute is performed by execution of a procedure for generating a guiding sound illustrated in FIG. 28, for example. When processing for generating a guiding sound-source attribute is started, counter i, distance variable rp, and angle variable θp are initialized and set to i=0, rp=0, and θp=0 (Step S71). The counter i, distance variable rp, and angle variable θp are variables used for generation of a guiding sound-source attribute, respectively. The counter i is a variable for counting the number of times of changing a sound source position SP. When the number of times of changing a sound source position SP is the maximum M, the counter i takes any of integral values from 0 to M−1, and the counter i is incremented by one (1) depending on the number of processing performed. Here, rp is a variable representing an immediately preceding distance r, or a distance r before the change processing. In addition, θp is a variable representing an immediately preceding angle θm or angle θ before the change processing.

Using i, rp, and θp, a sound source position SP (r, θ) at time t+iΔt is calculated using Equation (36), (37), (38), and (39) (Step S72).

$$\begin{matrix}r = rp + s / ( M - i ) & ( 36 ) \\ θ = θ p + λ / ( M - i ) & ( 37 ) \\ s = \sqrt{{( l cos Φ - rp cos θ p )}^{2} + {( l sin Φ - rp sin θ p )}^{2}} & ( 38 ) \\ λ = {tan}^{- 1} ( \frac{l sin Φ - rp sin θ p}{l cos Φ - rp cos θ p} ) & ( 39 )\end{matrix}$$

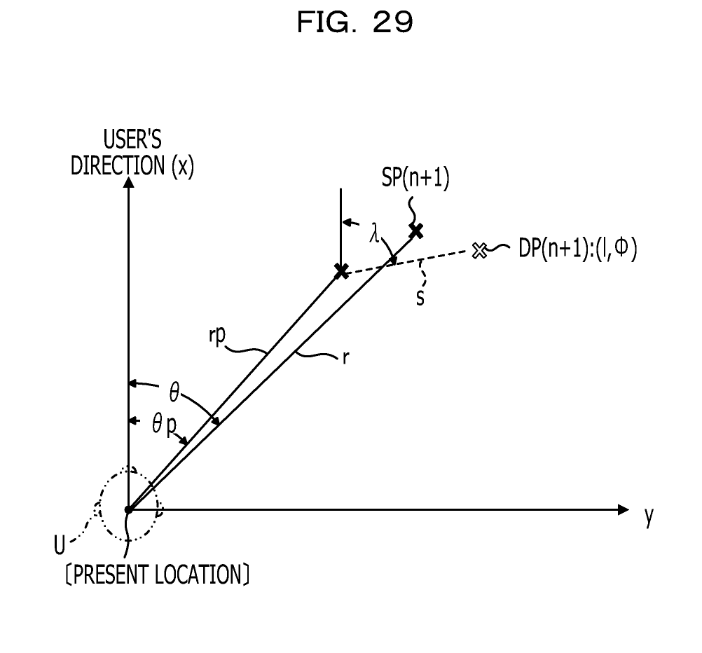

In these equations, “s” represents a sound source SP when a sound source position SP is located at (distance rp, angle θp), which represents a distance between a sound source position SP and a destination position DP; and “λ” represents an angle of a destination position DP with respect to a sound source position SP when the sound source position SP is at (distance rp, angle θp). In other words, “θp” represents an angle of a direction from a sound source position SP to a destination position DP with respect to an x axis in an x-y coordinate system illustrated in FIG. 29. When determining a distance r, a value obtained by dividing a distance s by a value (M−1) is added to an immediately preceding distance rp. When determining a distance θ, a value obtained by dividing a distance λ by a value (M−1) is added to an immediately preceding angle θp. When a value of i is small, “s/(M−i)” and “λ/(M−i)” is small and r and θ are also small. The values of r and θ become large and sound source position SP approaches the destination position DP as the number of performing processing increases. The guiding sound-source attribute generation unit 112 outputs values of r and θ as guiding sound-source attributes 116, and are applied to the sound source 10 by the guiding sound-source attribute application unit 114 (Step S62 of FIG. 27).

When calculating and determining values of r and θ, the counter i, distance rp, and angle θp are updated, followed by setting the counter i, distance rp, and angle θp to rp=r, θp=0, and i=i+1, respectively (Step S73). Then, it is determined whether generation and output of a guiding sound source is ended (Step 74). The end of the procedure is determined when an end notification is received from the outside (Yes in Step S74) and, for example, a guiding sound-source attribute generation unit 112 terminates a process for generating a guiding sound-source attribute. When the guiding sound-source attribute generation unit 112 does not receive a terminating notice from the exterior (No in Step S74), a processing for generating a guiding sound-source attribute is advanced and makes a judgment whether it is “i>M” (Step S75). When it is not “i>M” (No in Step S75), the process returns to step S72 and repeats calculation and determination of the distance r and the angle θ using the counter i, distance rp, and angle θp which are updated in step S73. When it is not “i>M” (Yes in Step S75), the process returns to step S71 to initialize the counter i, distance rp, and angle θ (Step S71), and repeats calculation and determination of the distance r and the angle θ using the counter i, distance rp, and angle θp which are being initialized.

When it is not “i>M”, calculation of distance r and angle θp is performed using the updated counter i, distance rp, and angle θp. A guiding sound-source attribute 116 is generated and outputted, where the sound source position SP is close to the destination position DP. When it is “i>M”, counter i, distance rp, and angle θp are reset, and distance r and angle θ are calculated, followed by repeating generation of a generation of guiding sound-source attribute 11 until an end notice is performed. Therefore, the user U can receive supply of a destination guidance sound 22 until the end notice is performed.

The guiding sound-source attribute generation unit 112 changes a sound-source attribute so that it may move to a destination position from a user position. The guiding sound-source attribute application unit 114 applies a guiding sound-source attribute 116 calculated by the guiding sound-source attribute generation unit 112 to the sound source 10. Thus, the guiding sound-source attribute application unit 114 may output a sound source having an attribute to be moved from a user's position to a destination. Since the guidance sound is emphasized as described above, a destination position, a destination distance, or a destination direction is represented intelligibly intuitively, and guidance becomes easy.

### Eleventh Embodiment

In an eleventh embodiment, a guiding sound-source attribute generation unit 112 (FIG. 25) causes a change in pitch sound-source attribute with a speed of a sound source on a stereophonic sound with respect to a user U (namely, relative speed between sound source and user). A pitch variation is expressed as a change rate Δp of sound source frequency, and determined using, for example, Equation (40) and Equation (41). Here, “V” represents acoustic velocity and “vs” represents the speed of a sound source (speed of sound source with respect to user U). Since distance r and immediately preceding distance rp are the same as those of the tenth embodiment, the description thereof will be omitted.

$$\begin{matrix}Δ p = \frac{V}{V - vs} & ( 40 ) \\ vs = ( r - rp ) / Δ t & ( 41 )\end{matrix}$$

The guiding sound-source attribute generation unit 112 outputs a change rate Δp of sound source frequency as a guiding sound-source attribute 116. The guiding sound-source attribute application unit 114 (FIG. 25) receives the input of change rate Δp changes a pitch of the sound source 10 using the change rate Δp, and generates a destination guidance sound 22 with a changed pitch.

Since other structural components are the same as those of the tenth embodiment, the same reference numerals will be provided and their descriptions will be omitted. The eleventh embodiment includes the configuration of the embodiment and also performs emphasis on distance and direction.

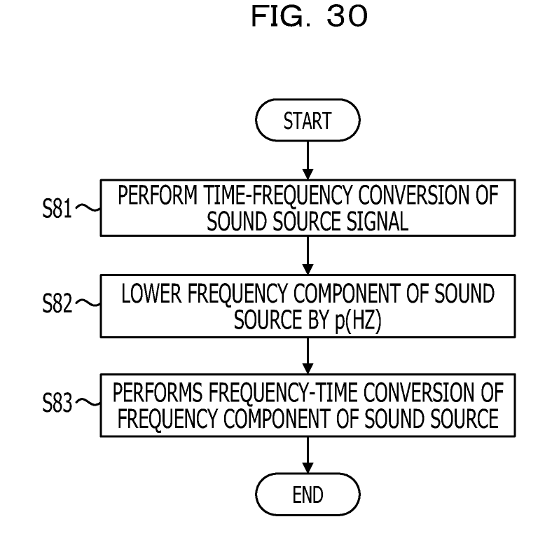

Next, FIG. 30 is referred for describing a process for changing a pitch of a guiding sound. FIG. 30 is a flowchart illustrating an exemplary process for changing a pitch of a guiding sound. This procedure is additional processing to be performed when the guiding sound-source attribute application unit 114 performs processing (Step S62 in FIG. 27) for applying a guiding sound-source attribute to a sound source.

The guiding sound-source attribute generation unit 112 performs time-frequency conversion of a sound source signal from the sound source 10 to obtain a frequency component S (Step S81). This time-frequency conversion divides a sound source signal into N frequency bands and then calculates a frequency component S for each frequency band. The frequency component is a complex number for every frequency (unit: Hz). The frequency component of a K-th frequency band is represented by, for example, S(k). When a sound source signal is divided into N frequency bands, for example, the division may be performed so that the widths of the respective frequency bands may be equal to one another. By dividing the frequency band in this way, management of bandwidths may be easily performed. Here, “k” is an integer in a range of 0 to N−1 and represents a divided band number.

Next, using a change rate θp, the frequency component of the sound is lowered by p (Hz) to change the frequency component of the sound source. A value of p for the reduction is calculated by, for example, Equation (42). And using value p, a frequency-band moving number j is calculated from Equation (43).

p=FΔp (42)

In the equation, “F” is a representative frequency of a sound source and set to, for example, 2000 (Hz).

j=round(p/Δf) (43)

In the equation, “Δf” is a value {f(k)−f(k−1)} obtained by subtracting (k−1)-th frequency f (k−1) from k-th frequency f(k) and represents a bandwidth of a frequency component; and “round( )” is a function that outputs an integer by rounding to the number of decimal places.

When the frequency bandwidth of each frequency component is set to Δf, a bandwidth corresponding to j components is p (Hz) or nearby p (Hz). Then, a frequency component S′(k) at a k-th band is obtained using Equation (44). Here, “S′(k) is a frequency component after frequency change.

$$\begin{matrix}{S}^{′} ( k ) = S ( k + j ) & k = 0 , … , N - j - 1 \\ {S}^{′} ( k ) = 0 & k = N - j , … , N - 1\end{matrix} \} \qquad ( 44 )$$

Subsequently, a sound-source frequency component S′(k) obtained by Equation (44) is subjected to frequency-time conversion (Step S83). Compared with a frequency component S (k), a k value of a frequency component S′(k) after frequency conversion is small as much as equivalent to j components. Thus, a sound source signal with a frequency lowered with p (Hz).

In this way, the pitch of the sound source 10 is changed. Therefore, the user may sense a change in pitch of a guiding sound source moving to a destination. This pitch change is heard so that the pitch may be lowered while a guiding sound source moves away. Thus, a destination direction may be further easily recognized compared with the case where only a position of a guiding sound source position is changed.

### Other Embodiments

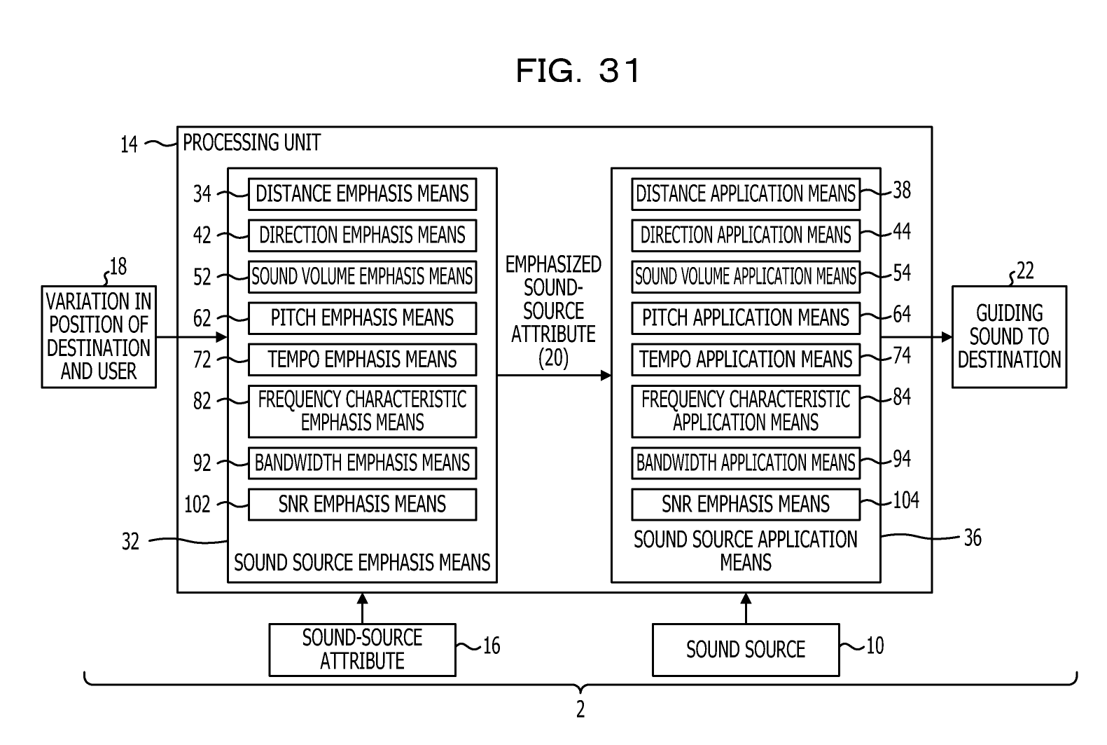

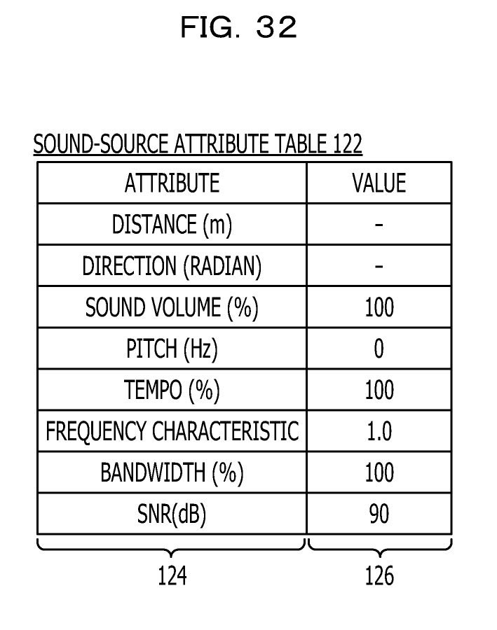

Second to ninth embodiments are configured so that a distance, a direction, a volume, a pitch, a tempo, a frequency characteristic, a bandwidth, and a SNR may be emphasized, respectively. Alternatively, the guiding sound generating apparatus may be configured to emphasize a few or all of these attributes. In this case, for example, the configuration of a guiding sound generating apparatus 2 may be one illustrated in FIG. 31. A sound-source attribute emphasis unit 32 is designed so that it includes emphasis units for emphasizing a direction, a volume, a pitch, tempo, a frequency characteristic, a bandwidth, and a SNR, respectively. A sound-source attribute application unit 36 is designed so that it includes application units for applying a direction, a volume, a pitch, tempo, a frequency characteristic, a bandwidth, and a SNR, respectively. Furthermore, a sound-source attribute table 122 illustrated in FIG. 32 sets sound attributes of a distance, a direction, a volume, a pitch, a tempo, a frequency characteristic, a bandwidth, and a SNR as attributes 124. It may be configured so that at least one of sound-source attribute of a distance, a direction, a volume, a pitch, a tempo, a frequency characteristic, a bandwidth, and a SNR is selected and input in a sound-source attribute emphasis unit 32 to execute selected emphasis unit and application unit. A value 126 corresponding to each sound-source attribute may be stored as represented by a sound-source attribute table 233 illustrated in FIG. 32. In the case of Δl=0, ΔΦ=0, the value 126 may be read out and used. Thus, it may be applied to the sound source 10.

[Hardware for Embodiments Described Above]

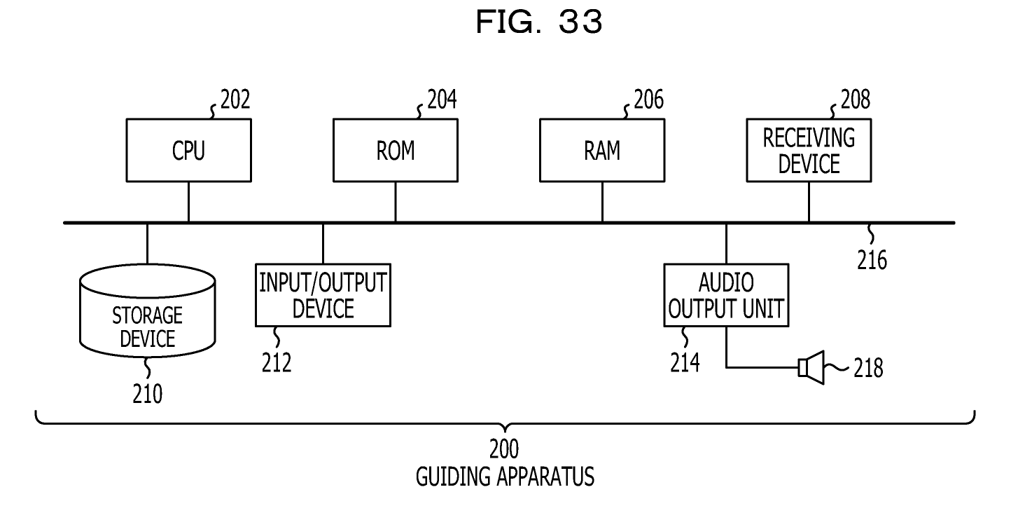

FIG. 33 is referred for describing a hardware used for any of the above-mentioned embodiments. A known guiding sound generating apparatus 2 as described above may be configured as a guiding apparatus 200 having a guiding-sound generating function. FIG. 33 illustrates an exemplary configuration of the guiding apparatus 200.

The guiding apparatus 200 illustrated in FIG. 33 illustrates CPU 202, ROM (Read-Only Memory) 204, RAM (Random-Access Memory) 206, a receiving device 208, a storage device 210, an input/output device 212, an audio output unit 214, and a bus 216.

The ROM 204 or the storage device 210 is an exemplary program storage unit. The storage device 210 may be any of storage devices, such as a hard disk or a magnetic disk. The storage device 210 or the ROM 204 store a program represented by the aforementioned flowchart and data of the aforementioned table 122, transmission characteristic data, and other setting values. In addition, the ROM 204 or the storage device 210 stores digital data, such as sound and audio and a sound source 10 may be configured of the storage device 210 and the ROM 204. The RAM 206 configures a work area. For example, the RAM 206 may store variables, such as rp, θp, and i, the maximum value M of the number of times of processing, and the number of times of dividing a sound source signal.

The CPU 202 executes a program described above and constitutes a processing unit 14 to execute emphasis and application of the aforementioned attributes, and the like.

The receiving apparatus 208 serves as a unit for receiving positional information, for example, one that receives a signal of location information 8 about a position of the guiding apparatus 200. When the location information 8 is received from, for example, a global positioning system (GPS), the receiving apparatus 208 may be a GPS receiver. Furthermore, for example, in the case of constructing the receiving device 208 as a communication device for communication with a base station, location information 8 may be generated using the base station.

The audio output unit 214 is used for outputting a guiding sound 22 to the aforementioned destination, specifically including a speaker 218 for converting electric signals into sound signals. Here, the speaker 218 may be an earphone, headphone, or a speaker for bone conduction.

The input/output device 212 used may be, for example, used as an input unit for setting a destination or inputting setting values.

The guiding apparatus 200 may be used as a guiding unit or a navigation unit and configured as, for example, a mobile terminal device, such as a cell phone; a navigation system, such as a car navigation system; or a personal computer (PC). Such a configuration of the guiding apparatus 200 may generate a guiding sound and outputs the sound to the outside.

Characteristic features, advantages, modified examples, and the like of the aforementioned embodiments will be mentioned below.

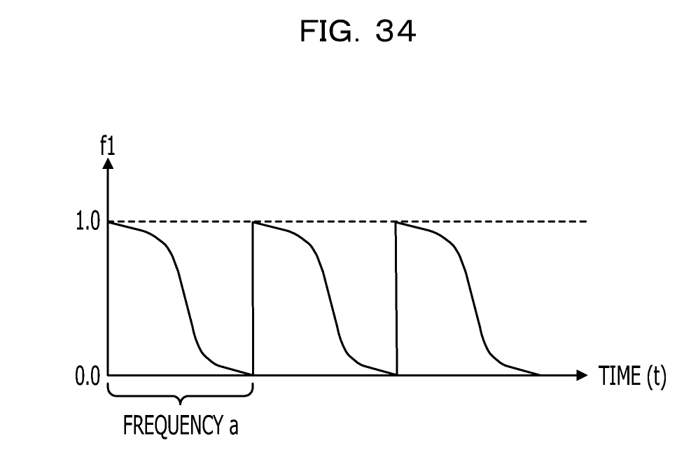

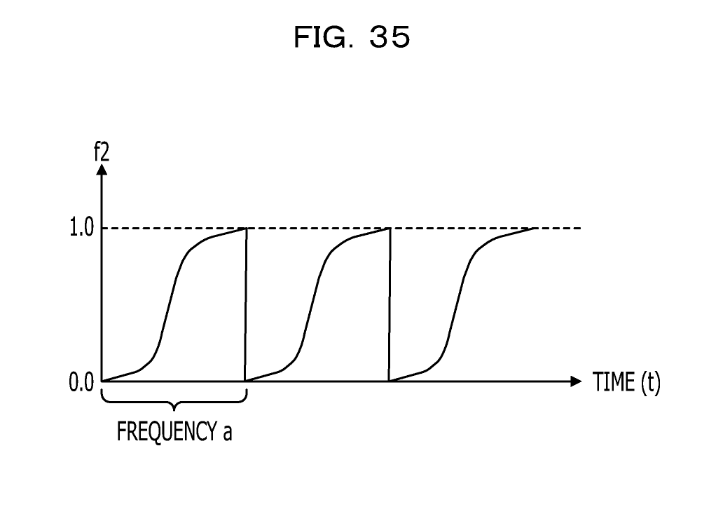

(1) In second embodiment, although the saw-tooth wave was used as f1 (t) and t2 (t), the embodiment is not limited to this configuration. The function f1 (t) may be one rapidly increasing to the maximum value and performing monotone decreasing from the maximum value to the minimum for every repeating frequency. The function f2 (t) may be one performing monotone increasing to the maximum value and, when reached the maximum, suddenly decreasing the minimum value. For example, a function of a repetitive decreases illustrated in FIG. 34 may be used as f1 (t) and a function of a repetitive increase illustrated in FIG. 35 may be used as t2 (t). The function of a repetitive decrease illustrated in FIG. 34 and the function of a repetitive increase illustrated in FIG. 35 are cosine functions using cosine as represented by Equation (45) and Equation (46), respectively.

$$\begin{matrix}f 1 ( t ) = cos ( \frac{π}{2} ( \frac{t}{a} - floor ( \frac{t}{a} ) ) ) & ( 45 ) \\ f 2 ( t ) = cos ( \frac{π}{2} ( \frac{t}{a} - floor ( \frac{t}{a} ) ) - \frac{π}{2} ) & ( 46 )\end{matrix}$$

(2) In second embodiment, although the function R (t) illustrated in FIG. 10 is illustrated, the present embodiment is not limited to such a function. For example, it may be of a monotone increase to Imax and fixed to Rmax when reached Imax. In addition, it may be an asymptotical function where Rmax x 0.9 is attained at Imax and then an increase in I allows a continuous approach to Rmax.

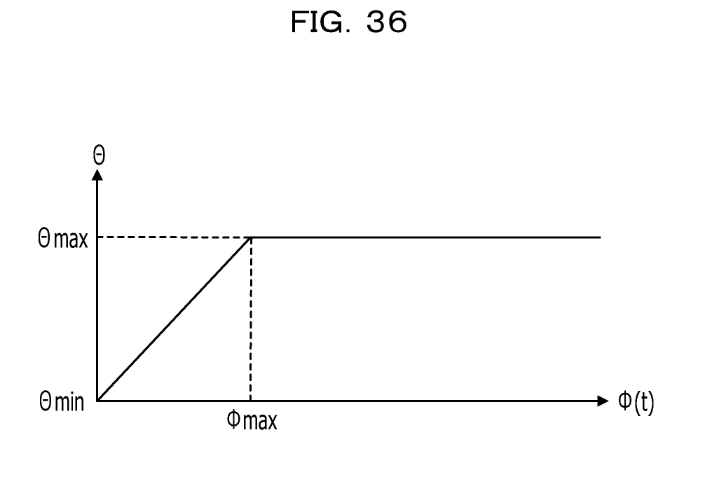

(3) In the third embodiment, in Equation (7), θ(t)=c (t) is set when ΔΦ(t)=0. Alternatively, however, θ (t) may be set using Equation (47). Function Θ (c (t)) illustrated in FIG. 36 is a function using an angle Φ (t) at time t and Θ representing an angle on a stereophonic sound as an axis. Function Θ (Φ (0) is represented by (Φ (t), Θ), including a region defined by linearly connecting between a point (0, Θmin) and a point (Φmax, Θmax) and a region where Θ=Θmax. When the angle Φ (t) is 0, it means that a destination is in front direction of the user U, for example, is set as 0 as Θmin. The value of Θ increases linearly as the angle Φ (t) becomes larger than 0 (zero). Thus, the angle Φ (t) becomes the maximum value Φmax and Θ reaches the maximum value (Θmax). When the angle is equal to or more than Φmax, Θ is set to a constant value as Θ=Φmax. In the function Θ (Φ (t) illustrated in FIG. 36, θ (t) is set to a value in proportion to the distance Φ (t) when the angle Φ (t) is in a range of 0 (zero) to Θmax. By setting up in this way, when ΔΩ (t) does not change, it can be set to a sound-source attribute according to the angle Φ (t).

θ(t)=Θ(Φ(t)) (47)

Not only in function Θ(Φ (t)) illustrated in FIG. 36, when a monotone increase is performed, for example, to Φmax and Φmax is reached, what is used is just a function which is fixed to Θmax. Alternatively, a function may be one continuously approaching to Θmax when it is set to Θmax×0.9 at Φmax and is increased.

(4) The second embodiment emphasizes distance and the third embodiment emphasizes a direction. Alternatively, a combination of distance emphasis and direction emphasis may be configured to emphasis both direction and distance. In this case, for example, both the distance emphasis unit 34 and the direction emphasis unit 42 may be set in the sound-source attribute emphasis unit 32. Both the distance application unit 38 and direction application unit 44 may be set in the sound-source attribute application unit 36. Therefore, it becomes easily recognize the distance to the destination and the direction of the destination.

(5) The fourth to eleventh embodiments emphasize and output the distance and the direction between the destination and the present location. However, it is not limited to such a configuration. Alternatively, for example, it may be configured to emphasize only one of distance and direction between the destination and the present location. In this case, it is possible to easily recognize the distance to the destination or the direction of the destination, which is being emphasized.

(6) In the second to ninth embodiment, although the sound-source attribute emphasis unit 32 receives specification of sound-source attribute 16, it is not limited to such a configuration. For example, when the sound-source attribute to emphasize is set up in advance, specification of this sound-source attribute may be omitted.

(7) In the ninth embodiment, in emphasizing SNR, white noise was used, but it is not limited to this. For example, even if it uses any of noises, such as a brown noise, pink noise, a blue noise, and a violet noise, a sound-source attribute may be emphasized.

(8) In the procedure which generates the guiding sound-source attribute of the tenth embodiment, after determining distance r and angle θ, it is determined whether the procedure is ended or not. However, it is not limited to such a configuration. The end of the procedure may be determined at any timing or may be terminated using an emergency stop measure, such as a forced termination.

(9) In the aforementioned embodiment, a sound-source attribute emphasis is referred to a change or replacement in sound-source attribute. Examples of emphasis on this sound-source attribute include a decrease in volume, a decrease in pitch, a decrease in tempo, an increase in change of frequency characteristic, a reduction in bandwidth, and increase in noise. Emphasis of a sound-source attribute may also include weakening a sound-source attribute.

(10) In the second to ninth embodiments, emphasis is performed differently depending on the cases when a variation Δl (t) of the distance and a variation ΔΩ (t) of the angle exceed 0, less than 0, or equal to 0. However, it is not limited such cases. For example, the size of a variation Δl (t) of the distance or a variation ΔΩ (t) of the angle may also be taken into consideration, and a sound-source attribute may be emphasized. For example, it may be configured as illustrated below.

The sound-source attribute emphasis unit 32 accepts an input of a sound-source attribute and a user's positional variation with respective to a destination. A sound-source attribute may be emphasized so that the user may easily sense a sound source as the user approaches the direction of the destination, depending on a variation Δl (t) of the user's position with respect to the destination. Alternatively, the sound-source attribute emphasis unit 32 may emphasize a sound-source attribute to make it difficult to sense a sound source as it moves away from the destination. When constituted in this way, the sound-source attribute application unit 36 applies the sound-source attribute calculated and emphasized by the sound-source attribute emphasis unit 32 to the sound source. Thus, the sound source with the emphasized attribute is output and the user may be intelligibly guided to the destination.

When a variation in user's position with respect to the destination changes in the direction which keeps away from a destination, the sound-source attribute emphasis unit 32 controls so that the distance (r) of a sound source becomes large at least among sound-source attributes. When constituted in this way, according to a user's positional variation, the sound-source attribute emphasis unit 32 makes a distance of a sound-source attribute small as it approaches a destination direction, while a distance of a sound-source attribute is increased as it keeps away from the destination direction. Therefore, since it can sense it intuitive that the destination got away, compared with the case where a fixed distance is made to orientate, a user can be guided intelligibly to the destination.

With respect to at least a sound source direction θ among sound source attributes, when a variation in user's position with respect to the destination changes in the direction of the sound source so that it moves away from the destination, the sound-source attribute emphasis unit 32 controls so that the direction θ of the sound source becomes large. When constituted in this way, depending on the user's positional variation, the sound-source attribute emphasis unit 32 makes the angle of the sound-source attribute small as it approaches the destination direction and the angle of the sound-source attribute is increased as it moves away from a destination direction. The angle may be changed larger than an actual change in angle between the user and the destination. Thus, compared with the case where a sound source is fixed in a direction of an angle equal to an angle between the user and the destination, the user may be more intelligibly guided to the destination.

With respect to at least a sound volume of a sound source among sound-source attributes, when a variation in user's position with respect to the destination changes in the direction of the sound source so that it moves away from the destination, the sound-source attribute emphasis unit 32 controls so that the sound volume of the sound source becomes small. When constituted in this way, according to the user's positional variation, the sound-source attribute emphasis unit 32 controls the sound-source volume so that the sound-source volume may become large when the user approaches the destination direction and the sound-source volume may become small when the user moves away from the destination direction. Since the sound volume may be changed more than a change in actual distance between the user and the destination, when compared with, for example, a system that presents a sound source with a fixed sound volume, the user may be more intelligibly guided the destination.

At least a pitch among sound-source attributes, the sound-source attribute emphasis unit 32 is controlled so that a sound source pitch becomes lower when a variation in user's position with respect to the destination changes in the direction which keeps the user away from a destination. When constituted in this way, according to the user's positional variation, the sound-source attribute emphasis unit 32 controls the sound-source pitch so that the sound-source volume may become larger when the user approaches the destination direction and the sound-source pitch may become smaller when the user moves away from the destination direction. Since the pitch may be changed more than a change in actual distance between the user and the destination. When compared with, for example, a system that presents a sound source of a fixed pitch, the user may be more intelligibly guided the destination.

Among sound-source attributes, when a variation in user's position with respect to the destination changes at least a tempo of a sound source in the direction which keeps away from the destination, the sound-source attribute emphasis unit 32 controls so that the tempo of a sound source becomes low. When constituted in this way, the sound-source attribute emphasis unit 32 controls the sound-source tempo so that the sound-source tempo may be increased when the user approaches the destination direction and the sound-source tempo may be decreased when the user moves away from the destination direction. Since the sound source tempo may be changed depending on a change in distance between the user and the destination, or whether the user moves away from the destination or approaches to the destination, the user may be more intelligibly guided to the destination as compared with other systems which present a fixed sound source tempo to the user.

Among sound-source attributes, when a variation in user's position with respect to the destination changes at least a frequency characteristic of a sound source in the direction which keeps away from the destination, the sound-source attribute emphasis unit 32 is controlled so that the frequency characteristic of a sound source becomes larger. When constituted in this way, the sound-source attribute emphasis unit 32 controls the sound-source frequency characteristic so that the sound-source frequency-characteristic slope may be increased when the user approaches the destination direction and the sound-source frequency-characteristic slope may be decreased when the user moves away from the destination direction. The sound-source attribute emphasis unit 32 is able to change the sound-source frequency-characteristic slope depending on a change in distance between the user and the destination, or whether the user moves away from the destination or approaches to the destination. Thus, the user may be guided more intelligibly to the destination as compared with other systems that present a fixed sound-source frequency-characteristic slope to the user.

Among sound-source attributes, at least, when a variation in user's position with respect to the destination changes at least a bandwidth of a sound source in the direction which keeps away from the destination, the sound-source attribute emphasis unit 32 controls so that the bandwidth of a sound source is decreased. When constituted in this way, the sound-source attribute emphasis unit 32 controls so that the bandwidth of the sound source becomes larger as the user approaches to the destination direction according to the positional variation of the user. In addition, the bandwidth of the sound source is set to become lower when the user moves away from the destination direction. The sound-source attribute emphasis unit 32 is able to change the bandwidth depending on a change in distance between the user and the destination, or whether the user moves away from the destination or approaches to the destination. Thus, the user may be guided more intelligibly to the destination as compared with other systems that present a fixed bandwidth to the user.

With respect to at least a SNR of a sound source among sound-source attributes, when a variation in user's position with respect to the destination changes in the direction of the sound source so that it moves away from the destination, the sound-source attribute emphasis unit 32 controls so that the SNR of the sound source becomes smaller. When constituted in this way, according to the user's positional variation, the sound-source attribute emphasis unit 32 controls the SNR so that the sound-source volume may increase when the user approaches the destination direction and the SNR may decrease when the user moves away from the destination direction. The sound-source attribute emphasis unit 32 is able to change the SNR depending on a change in distance between the user and the destination, or whether the user moves away from the destination or approaches to the destination. Thus, the user may be guided more intelligibly to the destination as compared to other systems that present a fixed SNR to the user.

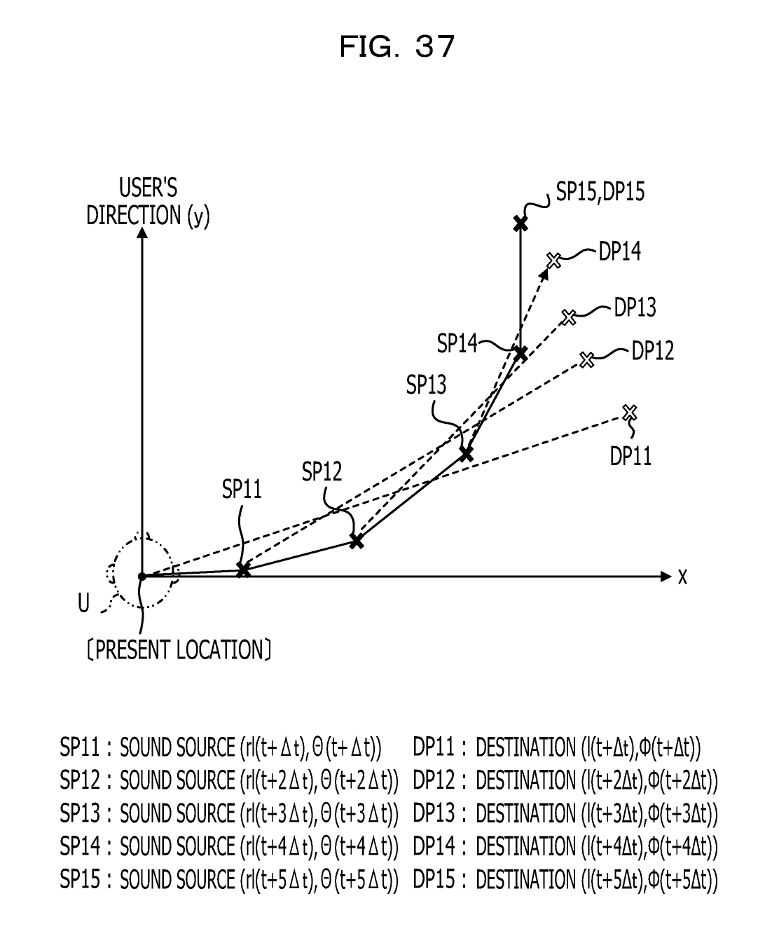

(11) In the tenth embodiment, when moving the sound source SP, the sound source is moved through the sound position SP from the front direction of the user U to the destination direction. However, it is not limited to such a configuration. For example, like the sound source position SP illustrated in FIG. 37, it may be moved from the side direction of the user U to the destination direction. In the case of the sound source illustrated in FIG. 37, the sound source is moved from the sound source position SP11 to the sound source positions SP12, SP13, SP14, and SP15 in this order. Even if the sound source is moved in this way, the angle of the sound source position is changed. Therefore, the destination direction may be emphasized.

(12) In the tenth embodiment, both the sound source distance and the sound source direction are moved. However, it is not limited to such a configuration. For example, at least distance among sound-source attributes may be changed so that the sound source is moved from a distance near to the user to a distance near to the destination. The guiding sound-source attribute application unit 114 may apply at least one of guiding sound-source attributes, which is calculated by the guiding sound-source attribute generation unit 112, to the sound source 10. In this case, the user U may sense a change in distance of the guiding sound source moving to the destination. Thus, the user U may easily have a sense of distance to the destination. Furthermore, as a distance change, for example, the variation of the distance attribute of the guiding sound source may be changed by the distance to the destination. In this case, the farther the user U is from the destination, the more the guiding sound source is heard such that the guiding sound source moves away from the location of the user to a farther position.

In addition to chance at least a distance, for example, the guiding sound-source attribute generation unit 112 may change at least a direction among sound-source attributes such that the direction is changed from the direction along which the user faces to the direction of the destination. Then, the guiding sound-source attribute application unit 114 may apply at least direction among the guiding sound-source attributes 116 calculated by the guiding sound-source attribute generation unit 112, to the sound source. In this case, the user U may sense a change in direction of the guiding sound source moving to the destination. Thus, the user may easily sense the direction to the destination and the angular difference of the direction. Furthermore, as a change in direction, for example, the variation of the direction attribute of the guiding sound source may be varied with, for example, a distance between the user and the destination. In this case, for the user U, the more the angular difference of the direction with respect to the destination is large, the more the user may be heard such that the guiding sound source is moved to a position where the direction of the guiding sound source is changed from the direction of the user.

All examples and conditional language recited herein are intended for pedagogical objects to aid the reader in understanding the invention and the concepts contributed by the inventor to furthering the art, and are to be construed as being without limitation to such specifically recited examples and conditions. Although the embodiments of the present inventions have been described in detail, it should be understood that the various changes, substitutions, and alterations could be made hereto without departing from the spirit and scope of the invention.

What is claimed is:

1. A guiding sound generating apparatus which generates a guiding sound for guidance from a present location to a destination, the guiding sound generating apparatus comprising:
a sound source;
a variable sound-source attribute unit that changes a sound source attribute depending on a position or a positional change of a present location with respect to the destination; and
an attribute-application unit that applies the sound-source attribute generated from the variable sound-source attribute unit to the sound source and generates a guiding sound where a sound-source attribute is changed by the position or the positional change of the present location with respect to the destination.

2. The guiding sound generating apparatus according to claim 1, wherein
the guiding sound is used for emphasizing information about a distance from the present location to the destination, information about a direction from the present location to the destination, or information about both the direction from the present location to the destination and the distance from the present location to the destination.

3. The guiding sound generating apparatus according to claim 1, wherein
the sound-source attribute includes at least one selected from a group consisting of: a distance to the destination, a direction of the destination, a sound volume of a sound source, a pitch of the sound source, a tempo of the sound source, a frequency characteristic of the sound source, a bandwidth of the sound source, and a SN ratio of the sound source, and
wherein the sound-source attribute is changed in response to a positional change of the present location with respect to the destination.

4. The guiding sound generating apparatus according to claim 1, wherein
the guiding sound constitutes a stereophonic sound as a combination of a plurality of sounds, and wherein the sound source of the stereophonic sound is moved in a direction along which the sound source of the stereophonic sound is guided to the destination with time.

5. The guiding sound generating apparatus according to claim 1, wherein when approaching a destination direction, the guiding sound is made clear.

6. The guiding sound generating apparatus according to claim 1, wherein
the movement of the sound source is one selected from a group consisting of movement of the sound source approaching the destination from the present location or a enamoring position thereof, and movement of the sound source approaching the destination from a front direction of the apparatus.

7. The guiding sound generating apparatus according to claim 1 wherein
the sound-source attribute of the guiding sound is changed in response to a relative velocity of the sound source.

8. A non-transitory computer readable medium storing program instructions for performing, when executed by a processor, a method of generating a guiding sound for guidance from a present location to a destination, the method comprising:
changing a sound-source attribute based on a current position and a positional change thereof with respect to the destination;
applying the sound-source attribute with respect to the destination; and
generating a guiding sound having a sound-source attribute changed by the current position or the positional change thereof with respect to the destination.
